(19) United States
(12) Patent Application Publication
(10) Pub. No.: US 2021/0326976 A1
(43) Pub. Date: Oct. 21, 2021

(54) System and Method For Simulating Financial Growth Over a Period of Time

(71) Applicant: Troutwood, LLC, Pittsburgh, PA (US)

(72) Inventors: Eugene M. Natali, JR., Pittsburgh, PA (US); Jeffrey Richard Davidek, Pittsburgh, PA (US); Dorian Brown, Pittsburgh, PA (US)

(73) Assignee: Troutwood, LLC, Pittsburgh, PA (US)

(21) Appl. No.: 17/224,062

(22) Filed: Apr. 6, 2021

Related U.S. Application Data
(60) Provisional application No. 63/005,857, filed on Apr. 6, 2020.

(51) Int. Cl. G06Q 40/02; G06F 30/20

(52) U.S. Cl. CPC G06Q 40/02; G06F 30/20

(57) ABSTRACT

In an embodiment, there is provided a savings simulation system, having:
a single general user interface; and
a computer connected to the single general user interface and having:
   a computer readable storage device having a database module for collecting, storing, and linking data associated with financial performance of a user account; and
   a central processing unit connected to the single general user interface and the computer readable storage device, and running a plurality of core modules running:
      a means for input for a user to select:
         a locality;
         a profession;
         a lifestyle choice;
         a selected number of years of run simulation; and
         a user's personal savings goal;
      a means for retrieving real-time income and cost of living expense data from a third party based on the user input of a selected locality, profession, and lifestyle choice;
      a means for presenting a simulated scenario modeling a financial outcome based on the user inputs and real-time income and cost of living expense data; and
      a means for generating a proposed financial plan for the user based on historical rates of return.

### CROSS-REFERENCE TO RELATED APPLICATION

This application claims the benefit of U.S. Provisional Patent Application No. 63/005,857, filed on Apr. 6, 2020.

### FIELD OF INVENTION

This disclosure relates to financial planning and investment education and, more particularly, to financial investment education by modelling the impact of lifestyle, career, and financial decisions, as it relates to retirement goals and savings. As taught herein, Applicant seeks to provide a simulation and game to model the results of financial, career and life decisions.

### BACKGROUND

Approximately 115 million Americans do not invest. Only 3% of children born in 2019 are likely to have a pension fund. Financial challenges to the general population are numerous, including a student loan crisis, which continues to grow. Corporations and even municipal and state governments are freezing or eliminating their pension plans. The minimum age for Social Security eligibility has risen and may continue to rise as its Trust Fund deficit grows. This cumulative reduction of the United States retirement safety net is an issue of national importance. The demand and need to help Americans, particularly young Americans, develop viable plans to achieve financial stability is very high. What is needed is a system that will help users develop viable plans, collect useful data, provide modelling of financial outputs in response to entered variables, and optionally provides for a financial simulation activity that may be utilized as part of an education curriculum. Such a system may beneficially provide users with a better understanding of the impact of financial decisions and life choices, and provide positive reinforcement and communication to help users implement, maintain, and successfully realize those financial plans and goals.

Federal agencies have been collecting vast amounts of data, in discrete data sets related to income and expenses, for many years. However, there is no agency assigned with the task of integrating these various data sets, from varying agencies, into a tool specifically intended to help users create a financial budgeting plan tailored to his or her own unique financial objective—even though the vast data could be extremely valuable in doing so. The agencies that collect and publish the data make no attempt to interpret the data as it pertains to unique individuals and do not offer any tool designed to communicate with users to reinforce positive investment behavior consistent with individual savings and investment objectives. What is needed is a system that will utilize published data, along with user inputs pertaining to the individual use, to provide useful savings and budget information to help the user achieve desired investment objectives.

### SUMMARY

In an embodiment, the system receives information regarding current statistics relevant to localities, professions, and lifestyle choices, and seeks user input to provide inputs or selections, such as lifestyle choices, career path, selected locality, and living expenses, along with user inputted financial goal selections and behaviors, whereupon the system provides a simulated scenario modelling a financial outcome, based on the decisions and data inputs. The present invention relates to a computer method and system for automated generation of a “Financial Plan”, based on user-selected parameters and presets. The Financial plan generated by the invention utilizes and incorporates data from various sources, including governmental financial statistics provided by Bureau of Labor and Statistics (BLS), Housing and Urban Development (HUD), etc.), as may be accessed using, for example the BLS Public Data Application Programming Interface (API) as applicable, and combined with user inputs into a provider database, then generates a proposed financial plan for the user. In an embodiment, the application operates via computer and/or mobile device, seeking user's inputs, accessing the information in a database, and providing a customized model budget to the user as part of the Financial plan.

In an embodiment, the system allows for a user to quickly investigate the effects of various life, career, financial savings and expenses choices, and where the system utilizes a financial model based on investment returns modeled upon historically observed financial market data, in combination with government collected statistics, and information gathered by Applicant's research regarding living expenses for geographic locales, which may include, as non-limiting examples, food costs, telecommunications costs, utilities, vehicle and transportation expenses, where the system models and determines a financial result affected by the various inputs, thereby allowing the user to see the impact and effect of various life and financial decisions upon retirement savings.

In an embodiment, the system comprises a computing device that generates a display and features an interface whereby the user may select or otherwise enter information. The computing device may be, for example, a personal computer, a tablet, a handheld mobile phone. The computer system may be in communication, whether wired or wireless, via any suitable communication protocol, with one or more databases and/or other computer systems. The user's computing device may access a software program (either onboard, or accessible via network connection) that seeks the user to enter selections in an interface. The selections determine the information the software must access, in generating a financial model, based on historical precedent, current statistics, and entered user choices. The system will model the performance of a retirement account, and provide feedback to the user, based upon the inputs entered. For example, the system may provide guidance, which may be part of a budget, informing the user as to how much to regularly contribute to a retirement account, in order to meet a stated goal, in light of the user selections entered into the model's interface. Additionally, the system may provide feedback in the form of an output in graphical form, or tabular form, which may include text commentary or encouragement, and may propose alternatives to the information entered by the user.

The system may also be employed in an educational setting, providing an alternative to, or as a supplement to an investment challenge requiring the user to invest a fictional amount in the market. With the current system, the user would be participating in a simulation, and be tasked with entering a career, which may be the users' choice or being assigned to the user, and further be asked to make a series of lifestyle, career and financial decisions over the course of the simulated career made up on repeating units. As the simulation progresses, the simulation may present (or the teacher may assign) choices or obstacles to the student, such as, buying a house (mortgage) or renting; whether to enter marriage, have children, and at what age to retire. In the savings simulation system, or as applied within the financial savings game, the stock market performance may be based on chronologically correct historical annual returns. Using historical data sets in this manner teaches users the short-term unpredictability of the stock market and long-term efficacy of continued investment for the long term. In facilitating the simulation, the teacher may serve as the “gamemaster”, to select or trigger events occurrences within the simulation, targeting one or multiple students within the class (such as a stock market crash). The system may provide instruction in the form of text, or alternatively, may provide informative and entertaining video segments embedded within the system, that are playable upon user selection. In this manner, the student would be able to explore topics and aspects that in which they have an interest. The student may wish to examine a variety of career paths, and through the simulation may do so, and see the effect of life choices and financial decisions.

In an exemplary embodiment, there is provided a savings simulation system, comprising:
a single general user interface; and
a computer connected to the single general user interface and having:
   a computer readable storage device having a database module for collecting, storing, and linking data associated with financial performance of a user account; and
   a central processing unit connected to the single general user interface and the computer readable storage device, and running a plurality of core modules running:
      a means for input for a user to select:
         a locality;
         a profession;
         a lifestyle choice;
         a selected number of years of run simulation; and
         a user's personal savings goal;
      a means for retrieving real-time income and cost of living expense data from a third party based on the user input of a selected locality, profession, and lifestyle choice;
      a means for presenting a simulated scenario modeling a financial outcome based on the user inputs and real-time income and cost of living expense data; and
      a means for generating a proposed financial plan for the user based on historical rates of return.

In an exemplary embodiment, the plurality of core modules further generate a personal savings calculator to provide an amount to invest for each year in retirement savings to meet the user's personal savings goal. The plurality of core modules may include a landing screen module to provide the user options to build the proposed financial plan. The plurality of core modules may further include a my profile module permitting the user to enter information about a user's current age, a location, and a number of years the user wishes to save to meet the user's personal savings goal. The location may be a geographical region. The lifestyle choice may be directed to the spending nature of the user. The my profile module may permit the user to enter information regarding status and amount of student loans.

In an exemplary embodiment of the saving simulation system, the plurality of core modules may further include a career module permitting the user to select a job title of the profession. The career module may further permit the user to select a level of experience for the job title of the profession.

In an exemplary embodiment of the saving simulation system, the plurality of core modules may further include a invest module permitting the user to enter inputs directed to expected saving and investments during a number of the selected years of simulation to define the user's personal savings goal.

In an exemplary embodiment of the saving simulation system, the plurality of core modules may further include a my plan summary module that generates a report directed to a statistical likelihood of achieving the user's personal savings goal. The my plan summary module may further generate a further report establishing a confidence interval.

In an exemplary embodiment of the saving simulation system, the retrieved data may be collected by governmental agencies or labor industries.

In an exemplary embodiment, the proposed financial plan may be dependent on the income data of a selected profession and cost data of living expenses for a selected geographical area from the user input. The proposed financial plan may be a budget plan that is specific to the user input of an estimated recurring amount of monthly contribution towards the user's personal savings goal.

In an exemplary embodiment, the proposed financial plan may generate a report indicating a likelihood of success of achieving the user's personal savings goal based on historical market return data for a selected investment vehicle.

### BRIEF DESCRIPTION OF THE DRAWING(S)

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 depicts a schematic diagram of the savings simulation system according to an exemplary embodiment of the invention;

FIG. 2 depicts an example of a non-traditional form of financial feedback provided to the user of the savings simulation system, according to an exemplary embodiment of the invention;

FIGS. 3A, B, and C depict an example of a traditional form of financial feedback provided to the user of the savings simulation system, according to an exemplary embodiment of the invention;

FIGS. 4A, B, and C depict a sample budget plan prepared by the savings simulation system, according to an exemplary embodiment of the invention;

FIG. 5 is schematic diagram of hardware infrastructure for a simulation savings system according to an exemplary embodiment of the invention;

FIG. 6 is a schematic diagram of hardware infrastructure for front end and back end framework of a savings simulation system according to an exemplary embodiment of the invention;

FIG. 7 is a schematic diagram of exemplary connection between a front end and a back end framework of a savings simulation system according to an exemplary embodiment of the invention;

FIG. 8 is a schematic diagram of exemplary protocol between a front end and a back end framework of a savings simulation system according to an exemplary embodiment of the invention;

FIG. 9 is a flow chart of exemplary steps performed by user authentication module for a savings simulation system according to an exemplary embodiment of the invention;

FIG. 10 is a schematic diagram of a savings simulation system according to the invention;

FIGS. 11-30 are exemplary images of the graphical user interface and examples of the service modules necessary for performing the tasks of the savings simulation module, according to exemplary embodiments of the invention; and

FIGS. 31-34 are exemplary images of career game card faces, according to an exemplary embodiment of the invention.

### DETAILED DESCRIPTION OF THE EMBODIMENT(S)

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will be thorough and complete and will fully convey the concept of the invention to those skilled in the art.

Other systems, methods, features and advantages of the invention will be or will become apparent to one with skill in the art upon examination of the following figures and detailed description.

In an exemplary embodiment, the invention provides a saving simulation module, having a plurality of modules configured to perform actions and calculations needed for the saving simulation module.

In another exemplary embodiment, there is provided a financial simulation game provides a financial simulation module, having a plurality of modules configured to perform actions for operating the financial simulation module. The financial simulation module may be usefully employed as part of a financial education curriculum, where users can explore career paths and financial decisions in a simulated career over the course of a plurality of turns, where the financial simulation exposes the user to the impacts of financial decisions.

### Saving Simulation System

In an embodiment, the teachings herein described a savings simulation system that allows a user to develop a viable financial plan that utilizes relevant data and user controlled inputs, as variables in the software. The savings simulation system has a savings simulation module that incorporates data collected by Federal or governmental agencies or labor industries, and related to income and expenses, along with information provided by the user into a tool specifically intended to help users create a financial budgeting plan tailored to his or her own unique financial objective. The savings simulation module may access databases and information, such as that collected by governmental and non-governmental sources. As non-limiting examples, the Bureau of Labor Statistics (BLS), Department of Housing and Urban Development (HUD), and other entities collect and publish vast amounts of data related to the income and expenses of Americans that may be accessed by the systems described herein. Recognizing the potential application of its data for constructive purposes the BLS, in fact, explicitly states on its website (https://www.bls.gov/developers/home.htm): “It is the Bureau's hope that talented developers and programmers will use the BLS Public Data API to create original, inventive applications with published BLS data.” While these data sets have value on a stand-alone basis, and the corresponding publishers have made tools to search and sort the data, to the best of Applicant's knowledge, none of the data publishers have identified or provided the benefits made possible through the various embodiments described herein, by having created a tool that integrates and shows the relationships between these data sets, and providing a system to model the impact upon a user's financial plans. Such a tool could be of significant interest to users, particularly minors and young professionals seeking to understand the relationships between various careers, income potential, geographic location, and cost of living and their desired long-term financial objectives. It is contemplated that various embodiments could be utilized as part of a financial education curriculum, or may be provided as a research tool made available to investors, researchers, or individual users, as may be helpful in establishing, or maintaining a personal budget.

In developing a “Financial Plan” it is necessary to know both expected income and expected expenses. The main variable for expected income is the career selection and career level, which may be provided/selected by the user. However, income and expenses vary with geographic locale; hence geographic location must be known to increase the accuracy of any projection utilizing the published data. It is necessary to know the monetary target which the user wishes to achieve and the amount of time in which they would like to achieve it. The system may also incorporate into the financial modelling specific financial factors relating to, for example, student loans, family size (dependents), or other debts. Utilizing these parameters, it is possible for the system to generate and approximate a plausible user-specific budget.

Having a budget and knowledge of financial goals however, is not enough, to achieve a savings and investment goal. The user must be disciplined and overcome multiple behavioral biases related to saving and investing. By developing a provider managed application, that integrates the user-defined goal with data collected from the provider managed investment application database, the provider of the simulation is able to notify users of the probability of achieving the unique, user-determined goal, based on investment behavior and to further reinforce discipline by sending prompts or notifications via SMS, email, within the app, etc. communicating information about adverse or positive changes in probability of success.

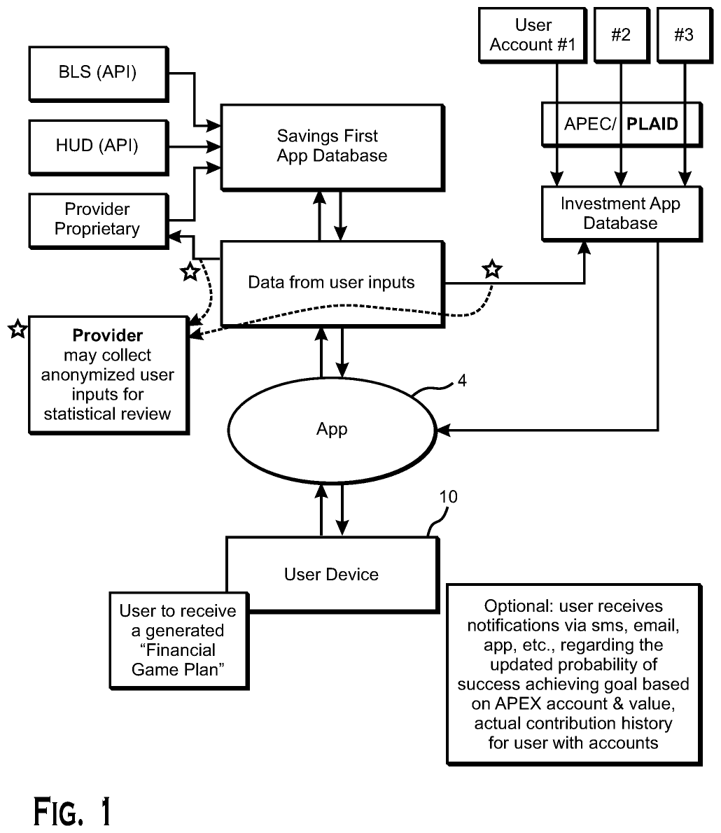

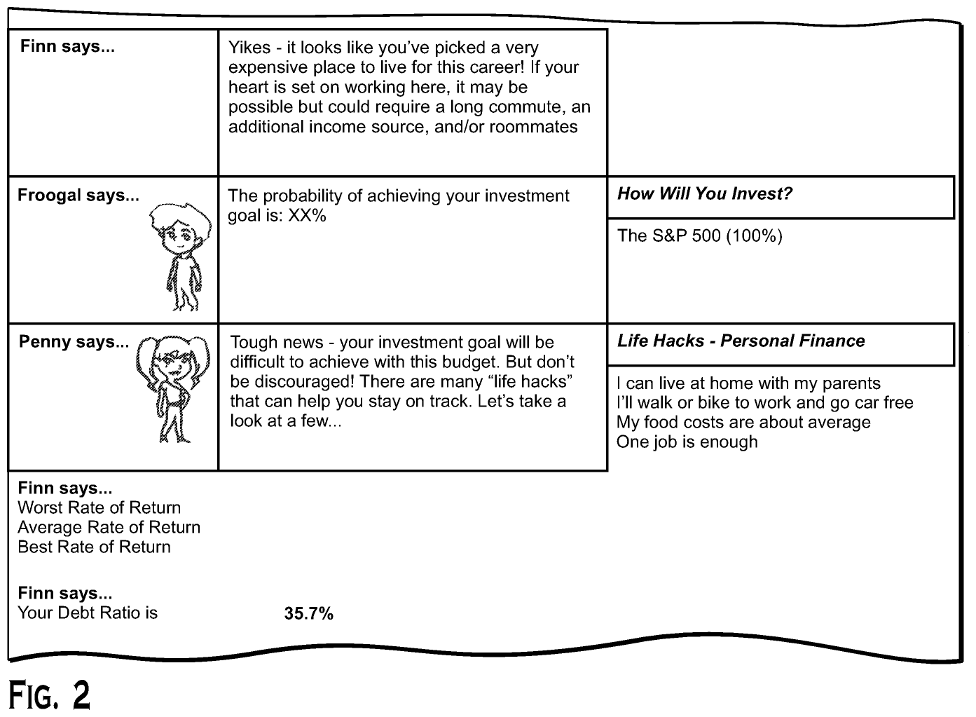

With reference to FIG. 1, an exemplary method of utilizing the system described herein utilizes inputs requested from the user. For example, the system may request the user provide input data, such as by providing a drop down or user selectable text field for at least one or more of the following:
Select a career (e.g., “Accountant”) and career level (e.g. “Entry Level”), which may reflect a user's subjective choice, or may, especially in an educational setting be based upon a career card.
Select a location, such as city and/or state and/or Metropolitan Statistical Area (MSA)/region.
Input a monetary goal and desired # of years to achieve that goal.
Optionally include any student loan information, such as loan amount, rate and term. Once the selections are made by the user, the selected or user entered information may be automatically directed as appropriate for use in the user's personal plan (e.g., within the savings simulation system) or into the user's character information (e.g., within the financial savings game).

The user data inputs may be facilitated through a graphical user interface that is presented to a display on a computing device utilized by the user. The computing device may be any suitable device or system suitable for receiving and processing information known to those skilled in the art, for example, a computer, a tablet, a mobile device, or portable media player. The user's computing device may have or run software, such as an application, or alternatively may provide a method of accessing a network or other device that runs the necessary processing, such as via an internet connection, where the calculations are performed on software located away from the user's computing device. In either circumstance, it is contemplated the results are presented to the user's display. Where the software processes remotely away from the user's computing device, for example, the results may be reported through a wired or wireless network connection to be displayed on the user's display or device.

The software, which as described may alternatively be an application on the user's computing device or remotely located and accessed electronically using techniques known to those skilled in the art, may be provided with, or otherwise access information from an investment information database, which may include user account information (such as savings, student loan information, investments, or other debts). The user financial information may be accessed through data collection agencies, such as APEX, Drivewealth, TD Ameritrade, Schwab. In an exemplary embodiment, the financial information may be accessed through an application-programming interface (API), such as Plaid, or any suitable API that allows the secure sharing of a user's financial account information with applications or programs on an authenticated computing device; or the savings simulation system may alternatively connect directly to the appropriate financial institution hosting the user account, e.g., through a portal or internet accessible server, and thereby can provide current financial information status for the user account. For either suitable source of financial information, such as the third party API, or the financial institution, the application server should be capable of accessing the user's financial information electronically in a secure manner, using techniques known to those skilled in the art. The necessary hardware and procedural flow for such interactions will be described below. These data collection agencies, may serve as banker custodians and/or broker/dealers responsible for providing custody of client assets and facilitating client transactions. Typically, 3^{rd} party provider user accounts are custodied at agencies such as APEX, banking institutions, or other data collection agencies, and the system may access data from the accounts and collect information on the timing, amount, and frequency of deposits and withdrawals. The system then reviews the collective data for each user, and interpret the timing of investments and withdrawals received by the account custodians, whereupon the system may make recommendations to the user, based on current user-specific information. The feedback the system may provide to each user may provide updates or alerts to inform the user if his behavior is increasing or decreasing the users' statistical likelihood of meeting his financial goals entered into the system. For example, the feedback may indicate if that user, based on the most current information and pattern of behavior is on track, or slipping off track towards the set long-term financial goal. It is contemplated that the feedback provided through the system may be an alert within the system that the user receives on the display. Alternatively, the feedback may be routed to the user via alternative methods, such as an email, or SMS text message. It is contemplated that the alert may be routed to the user's smart watch or wearable fitness monitoring device, thereby providing readily accessible and effective encouragement towards the user saving towards a long-term goal.

With inputs provided by the user, and optionally, with inputs concerning the user's current financial information, the software may access a Savings First Application database that may be embedded within the software on the user's computing device, or remotely located, as previously described. The Savings First database would include information gathered from BLS, HUD, and provider managed database describing approximately 1000 careers, and utility costs, food costs, transportation costs, insurance costs by geographic locale (approximately 2,700 city/MSA options in all 50 states, and territories of the USA. It is contemplated that the database may be expanded to have international application. Data sets and statistical information utilized in the calculations within the systems may include, but are not limited to: Rent, home cost data organized by geographic locale and residence type (Studio, 1-4 bedroom residence); Federal, State, and local tax rates for contemplated income levels; expenses such as auto insurance, and car payments and transportation expenses by geographic location, average food expenses by geographic locale; utility costs by geographic location; employment and compensation or income information by career/job title and geographic locale. Data sources accessed by system for generating the simulation may include: Bureau of Labor Statistics (BLS); Dept. of Housing and Urban Development (HUD); tax rates from State, Localities, and Federal sources; and statistics from historical investment returns. Applicant generated data sources accessed by system for generating the simulation may include: Career information database; Utility, Food, Transportation, Insurance costs database; and formulas using the data inputs for generating the simulation outcome.

It is contemplated that the software would run algorithms utilizing the user entered information, along with financial inputs, and Savings First database, to generate a personal savings calculator, which describes the user's calculated personal savings goal, as the amount to invest each year in retirement savings at a target savings rate (as a percentage of income), so as to allow the user to meet the selected goal, given the other parameters entered, in light of the entered career and location information.

After the system utilizes all the inputs from various sources, and processes the information in an algorithm within the software, the system will:
Generate a viable budget plan that is specific to the user selected career, geography, and goal; including an estimated recurring amount of monthly contribution towards a retirement fund, needed to achieve the user selected goal, and provide an indication of the likelihood of success of achieving the goal based on historical market return data for a selected investment vehicle, such as, for example, the S&P 500. The indication may be a provided as numerical probability, or may be text indicating the likelihood assessment (e.g., very likely, likely, possible, unlikely, very unlikely), or provide detailed assessment in the report indicating the factors that affect the likelihood of success in achieving the selected goal.
Allow the user to elect to receive optional automated notifications via SMS, email, within the provider managed application, etc. communicating whether the user is “on track” to achieve their savings and investment objective based on user financial behavior (tracked via the app, with user permission). The notification may assign “probability of success” based on the data collected by the provider managed application.

In an exemplary embodiment, the user may enter an age, and saving goal for retirement. Within the system, the simulation may, apply the statistical information gathered in the database, based upon the user's inputs concerning career selection and career track. Utilizing historical rates of return data from an investment market (such as the S&P500), the simulation may apply an “average”, “best” and “worst” case scenario for the market performance. For example, based on historical rates of return, an average rate of return for the period of time indicated may be provided. In an exemplary embodiment, the calculated rate of return for at least 20 years of investment growth in the market may be, for “average” growth, between 10 and 15%, typically 12.5%; the “best” rate of return may be between 15% and 20%, typically 18.5%; and the “worst” rate of return may be between 5 and 10%, typically 7%. Furthermore, for each return scenario, the simulation would provide guidance as to how much monthly investment would be required to achieve the desired savings goal for retirement. For the example provided above, where the user has 21 years before retirement, and a retirement savings goal of $2,000,000, the user would receive feedback output of:

“Average”=$1,916 Required Monthly Investment in S&P 500 (12.51% rate of return)

“Best”=$889 Required Monthly Investment in S&P 500 (18.58% rate of return)

“Worst”=$3,695 Required Monthly Investment in S&P 500 (7.05% rate of return).

The feedback provided to the user may be presented in a non-traditional form, by not being solely in the common graphical or tabular form, and may instead include, for example, commentary or messaging from one or more animated or cartoon characters intended to represent financial coaches. Part of the feedback may allow for the selection of alternative investment vehicles (e.g., S&P 500 index fund, or a balanced portfolio, for example, the portfolio may invest a percentage of the total in an S&P 500 index fund, and the remainder percentage in another vehicle, such as Barclay's Aggregate Bond Index. The selection of different financial vehicles may provide greater returns, albeit with greater risk profiles, or vice versa. Example feedback can be seen with reference to FIG. 2, as a representative of the nature of the feedback which may be provided to the user's display. The feedback may optionally include action prompts, for example, where a budget generated is not plausible, the feedback may suggest reducing housing costs by taking on a roommate, or taking on a 2^{nd} job, in order to achieve the desired financial goals, within the other limitations provided.

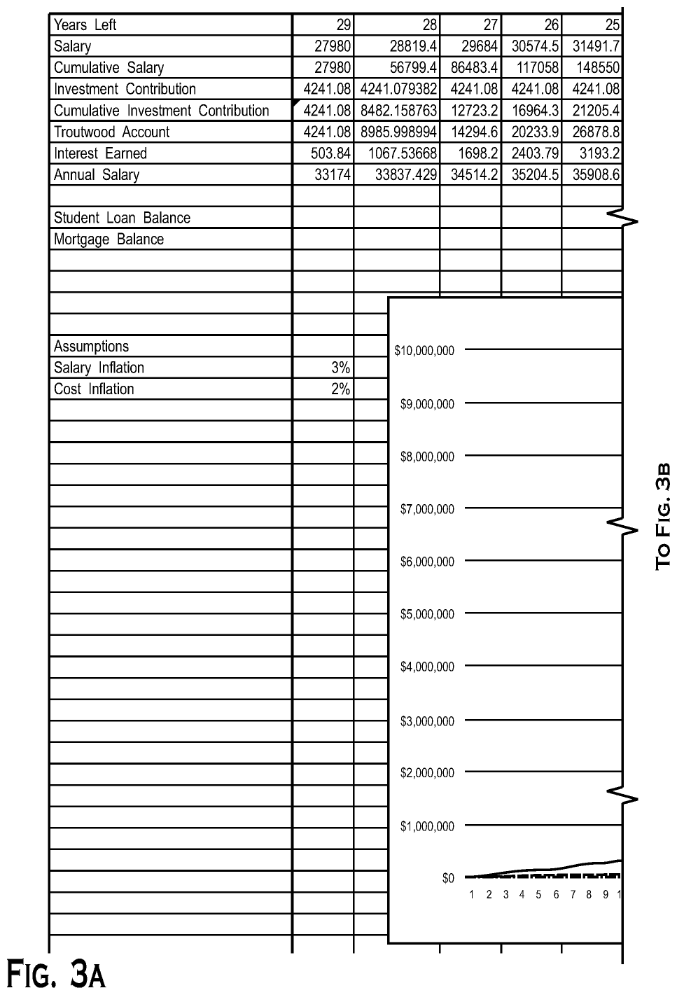

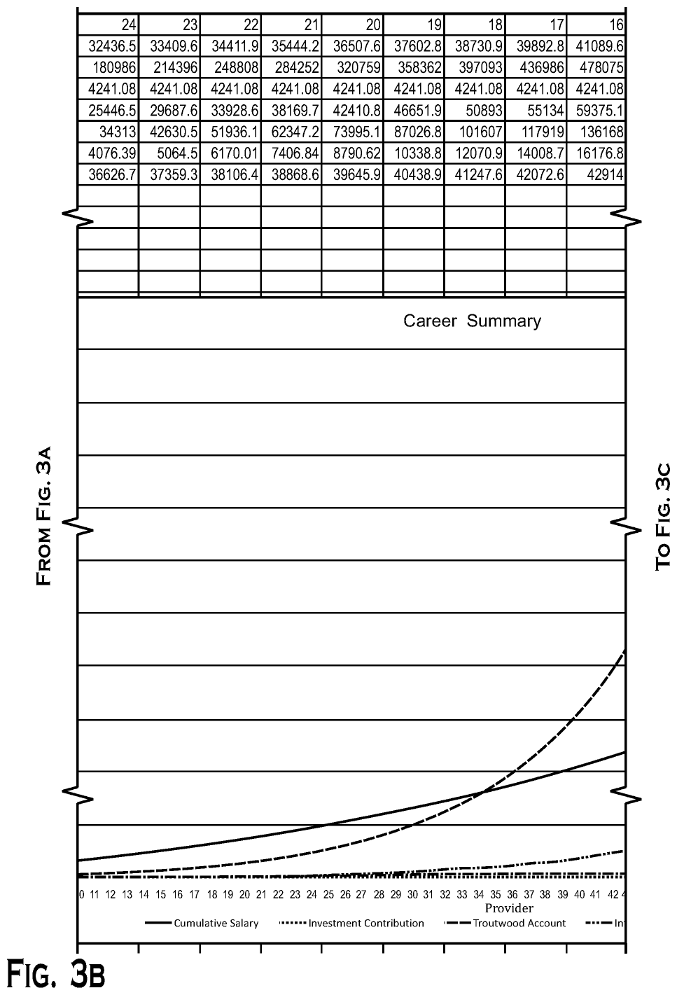

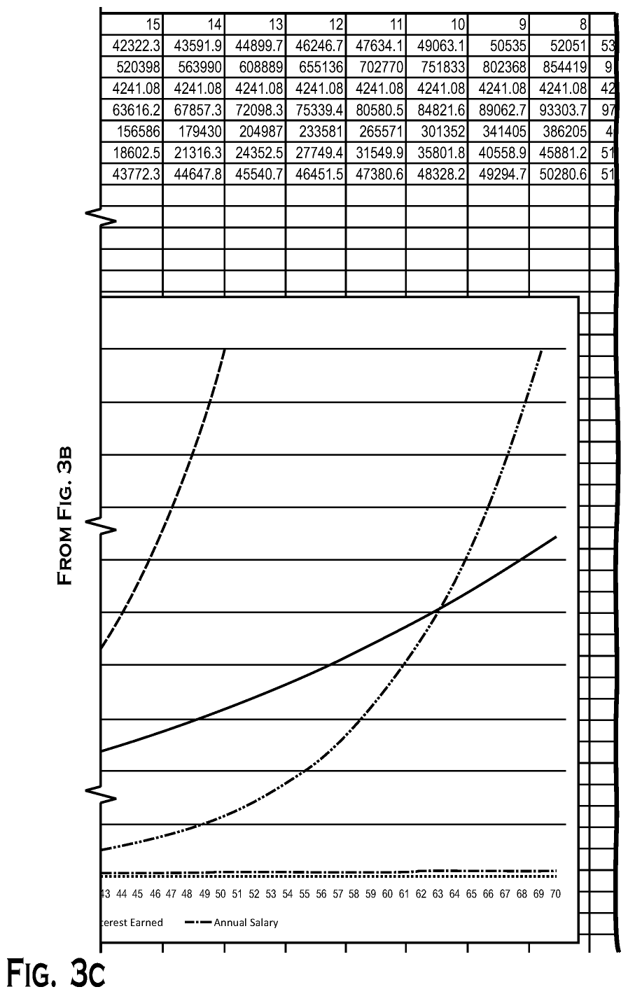

Alternatively, feedback towards the retirement saving goal may be provided in traditional form, such as presented in graph form (e.g., line or bar chart), and optionally summarized in tabular format, as can be seen with reference to FIGS. 3A, B, and C, collectively.

In such a graphical output, there may be displayed output and yearly results for a simulation of a financial growth over a lengthy period of up to, and possibly exceeding 30 years, where along the “x” axis of the chart there is a yearly progression, and along the “y” axis of the chart the monetary value would be displayed. These assignment of the axis may be varied, and still convey useful information regarding the financial history, or simulated history. In an embodiment, the user can select which elements to be displayed, and select a year range to be displayed. For example, the user may only want to display a 20 year period, or a 10 year period. Furthermore, the elements value represented over a period of time, which may be displayed on the chart, as can be seen with reference to FIGS. 3A, B, and C, may include: cumulative salary; investment contribution, total account value (provider account value), Interest earned, and annual salary, for example. It is contemplated that other statistics known to those familiar with the relevant field may be additionally displayed, or replace those items depicted in FIGS. 3A, B, and C, including statistics such as income, mortgage payoff, taxes, home equity growth, as non-limiting examples. The user may select to display one or more characteristics or items on the graph, and may selectively toggle on and off the display for each item on the chart individually or collectively in groups.

One of the benefits afforded by the systems described herein is that they may help individuals develop, implement, maintain, and successfully fulfill a plan for financial stability or independence. Through the use of the systems described herein, critical life skills and financial decision making skills may be taught to the user. One output that assists the user in understanding the impact of financial decisions is the sample budget that would be prepared, based on the inputs provided. An example of the system prepared budget can be seen with reference to FIGS. 4A, B, and C, collectively.

The simulation may be usefully employed by educators, using the tool in their financial literacy classes, to teach the students the importance of savings and investment, and further to the concept of living within a budget in order to achieve financial goals and retirement expectations.

Additionally, It is contemplated that the systems may be utilized by investment professionals and financial advisors in their client meetings and presentations, and may make the system or software for the system available as a research tool for customers.

It is contemplated that the wide distribution of the software or application to users will raise financial awareness, and serve as a valued resource that drives traffic to social media sites and websites for financial advisers and institutions. Such software may provide potential licensing revenue, as the savings tool may be potentially linked to, or incorporated into, major websites and financial advisory portals and may allow these financial advisers and institutions to link accounts directly the Troutwood APP and/or vice versa link the Troutwood APP directly to their respective customers' investment accounts.

In an embodiment, the system may utilize electronic instruction, such as may be automatically generated within the system software, after having determined a calculated personal savings goal amount, to provide for an “invest now” feature. Selection or otherwise triggering of the “invest now” option will instruct the system and/or software to send an instruction to the appropriate financial account (savings, checking, money market, etc.), typically a non-retirement account tied to the user, and cause an amount of money matching the calculated amount of the savings goal or the calculated amount of the calculated recommended contribution to be directed into the user's retirement account. The selection of this “invest now” feature may also enable the user to choose to initiate a monthly contribution in the calculated amount to repeatedly occur, until instructed otherwise, or until the calculated savings plan is updated with more recent information, and the invest now feature is activated to cause the revised amount to be directed from the appropriate account to a retirement account. It is alternatively contemplated that selection of the “invest now” trigger may result in the software implementing a single transfer as a non-repeating event. It is contemplated that the “invest now” selection may initiate the transfer between accounts held by the same institution, or may facilitate transfers between accounts held by different financial institutions (e.g., where the savings account is a bank, such as PNC bank, for example, and the retirement funds are with a distinct financial institution, such as Vanguard, Fidelity and the like). Such exchanges between different entities or institutions are known, and may be facilitated utilizing an exchange such as Automated Clearing House (ACH) to coordinate electronic payments and automated money transfers between accounts with different entities, with the consent of the owner.

It is also contemplated that the information entered within the system, whether entered by the user, or otherwise accessible by the software for the purposes of running a simulation within the system may facilitate the user's investment and entry into the financial market. For example, FINRA requires a broker/dealer to assess an investor's suitability prior to the investor entering into an investment. It is contemplated the system may have access to all, or substantially all of the information the broker dealer may need to assess the suitability requirement for an investment. For example, basic information about the user's age, income, career choice, locale, and investment goals may be provided by the user, as background information required for the simulation. The system may access information about the user's accounts, and current value. With this information, the system may be able to provide a list of suitability assessments statements for review by the user, who may confirm, or modify the outcome of the suitability determination. Upon confirmation of the statements by the user, the system may allow the broker dealer to have confirmation of the investor's subjective suitability for an investment.

As widespread use of the tool occurs, and many users are running the simulation, the resulting data may be usefully studied, and may be collected appropriate entities, for example, the organization providing or supporting the software. The collected information may include: the respective rates various careers are searched by the users, data on the savings/investment goals the users select or enter; geographic locale selection frequency, and details on financial behavior, such as identifying frequency with which users are in conformance or non-conformance with the planned budget; the average user's probability of success, based on inputs and historical market data; the average users' student debt; and user entered budget values. For users who have selected the option to link the application to an investment account, the system may collect information about the users' actual saving and investing behavior, and allow assessment if the behavior is consistent with a high probability of achieving the users' self-selected goal. Collected user-input data may be stored via a provider managed database, then utilize machine learning to anonymize and build a provider managed budget database, which may become more granular and realistic than the data set collected by the U.S. Govt.

To the best of Applicant's knowledge:
There is no tool available that integrates all of these vast data sets into one app, along with optional user financial data (e.g. student loan information) generating a plausible budget linked to a user-defined savings and investment objective;
There is no tool available that optionally monitors user financial behavior within a provider managed investment or financial planning app, then sends the user optional notifications (including projected future value and probability of achieving their custom savings and investment goal) to reinforce positive investment behavior; and
Further, the provider managed investment or financial planning app would be free of conflict, allowing the users to work with the distinct financial planning institution of their choosing.

For an exemplary embodiment of the savings simulation system, the various aspects and benefits of the invention will be described with reference to the following figures. The savings simulation system may be cloud-based, such that the information may be accessed and distributed via the internet and may utilize one or more servers or data processors that are remote from the location of the user. The terms “cloud-based savings simulation system” and “savings simulation system” will be used interchangeably herein. The savings simulation system 100 simulates financial performance of a user in light of user selections, provided through various modules, including the savings simulation module having at least a “plan builder module”, a “my profile” module, a “career module”, an “invest module”, and “my plan summary module”. Upon completion of the modules in the savings simulation module, the user is provided financial performance feedback that can be viewed by the user on a display. The savings simulation system 100 employs software and hardware, as will be discussed.

An overview of an exemplary embodiment of the process flow and interactions between component devices and information sources for the operation of the savings simulation system will be described with reference to the simplified schematic diagram of FIG. 1, with additional detail provided in the figures referenced below.

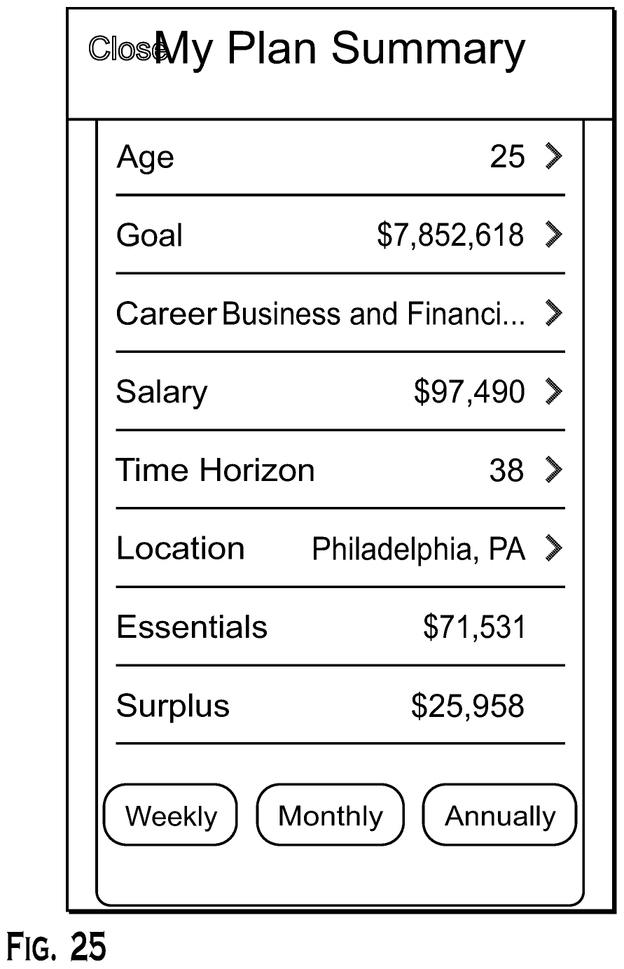

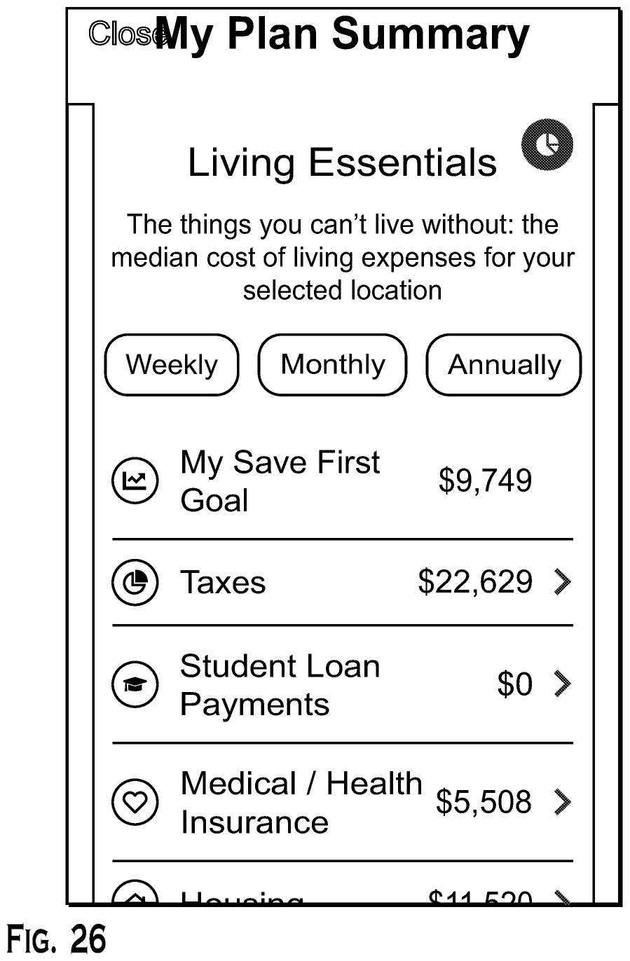

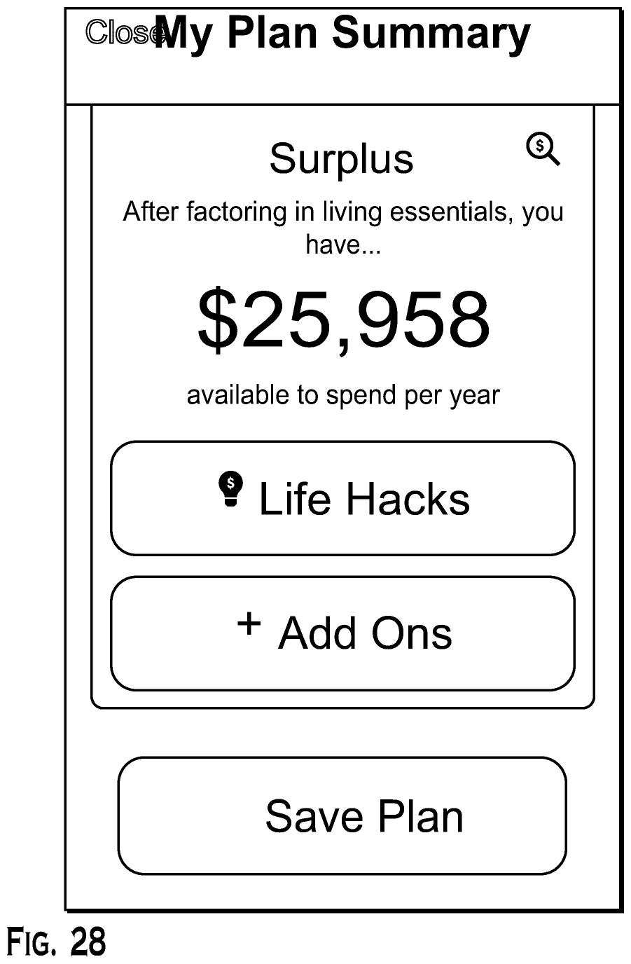

With reference to the FIGS. 1, and 5-30, various aspects of the hardware, modules and methods of use of an exemplary embodiment of the savings simulation system are further described.

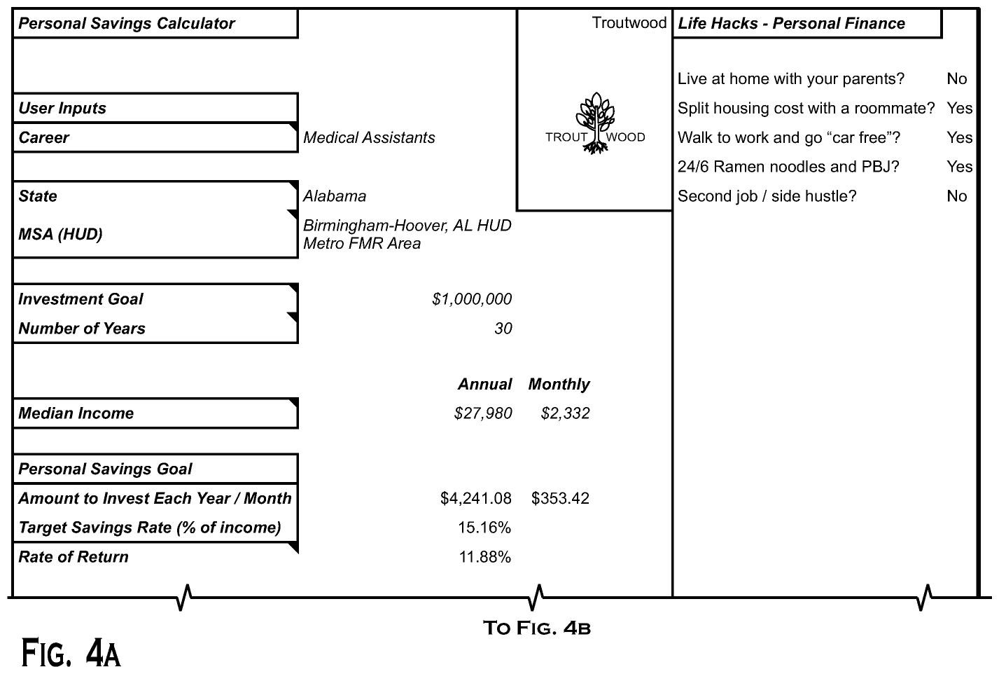

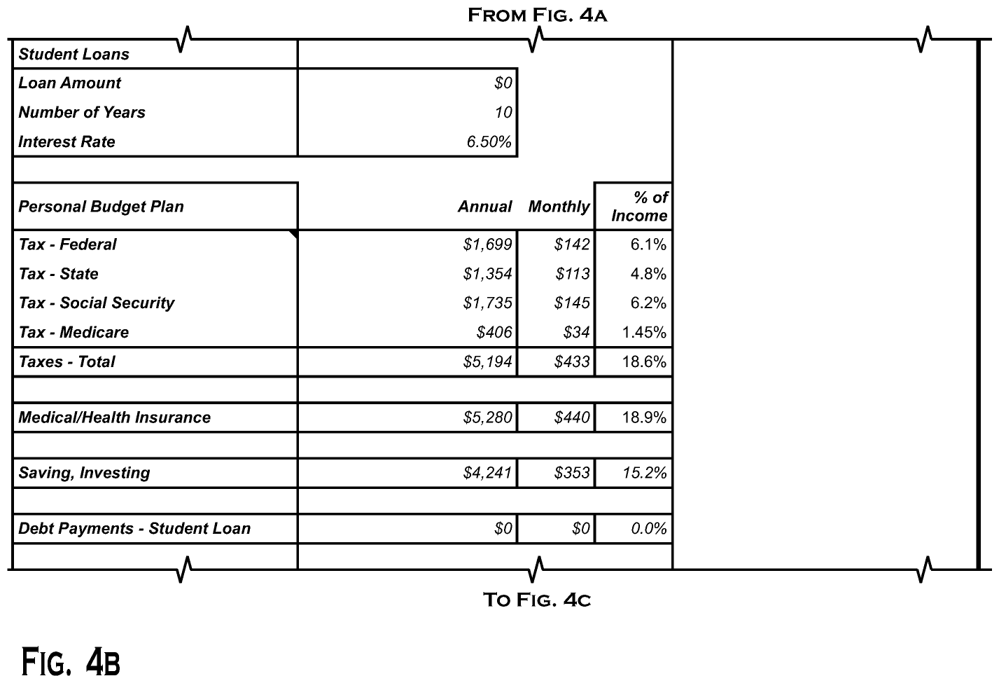

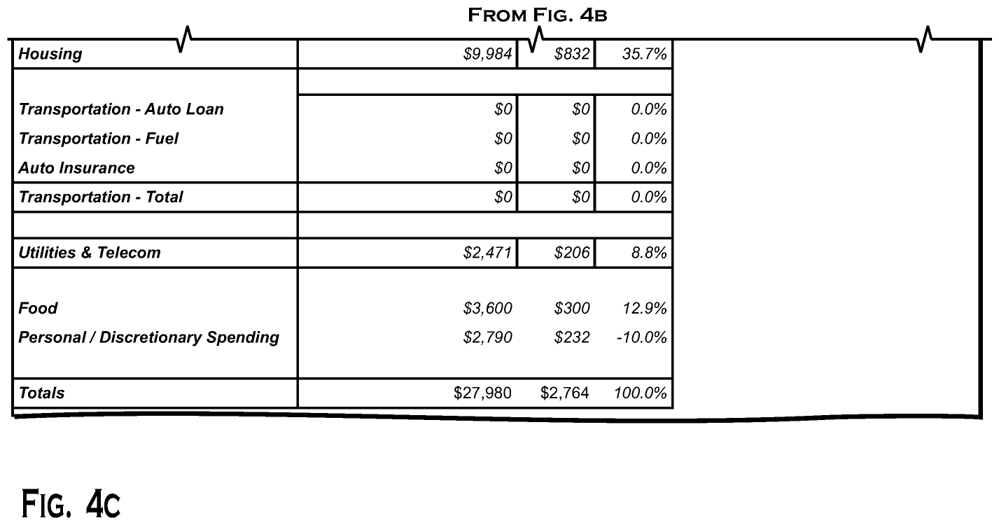

The hardware infrastructure for an embodiment of the savings simulation system 100 will be described. In an exemplary embodiment, the hardware infrastructure has a system architecture as depicted with reference to FIG. 5, and is built on one or more network routers 2 (for instance, a wireless router) and connected to a database application server having access to one or more databases files, while also utilizing known hardware components, including a web server 5, a firewall 6, a network 9, and the computing device 10 of the user. It is contemplated that, in an embodiment where the user's computing device is a terminal such as a PC or laptop, for example, the computing device 10 may be directly connected by network communication cable to the router 2, and the wireless router depicted may not be necessary. More commonly, the user end of the network 9 is provided with a computing device 10 that is a laptop, PC, tablet, or smart phone that can communicate wirelessly, and access the internet through a wireless communication system, such as a wireless router or using cellular signal, as will be familiar to those of ordinary skill in the art, that the computing device may connect to the internet, or be directed through a network router 2 in order to access the internet, as shown in FIG. 5. In an embodiment, the computing device 10 may be a tablet computer or smart phone with a touchscreen display 11. The touchscreen display 11 may use finger or stylus gestures to navigate the general user interface (GUI) provided on the screen by the software. However, one skilled in the art should appreciate that other implements could be used; including a computer mouse, a keyboard, or joystick. In fact, one skilled in the art should appreciate that the computing device may be a physical computer and could be, but not limited to, a desktop computer, a laptop computer, or a cell phone, and utilize a downloaded app or web browser. The computing device 10 is to be provided with memory device that is a storage device having computer components and recording media used to retain digital data. The processor of the computing device is a central processing unit (CPU) that manipulates data stored in the memory device by performing computations. The interaction and communications between the graphical user interface and the display visible to the user (the front end) and the interactions with the database, or financial account information (the back end) are depicted in the simplified schematic of FIGS. 6 and 7.

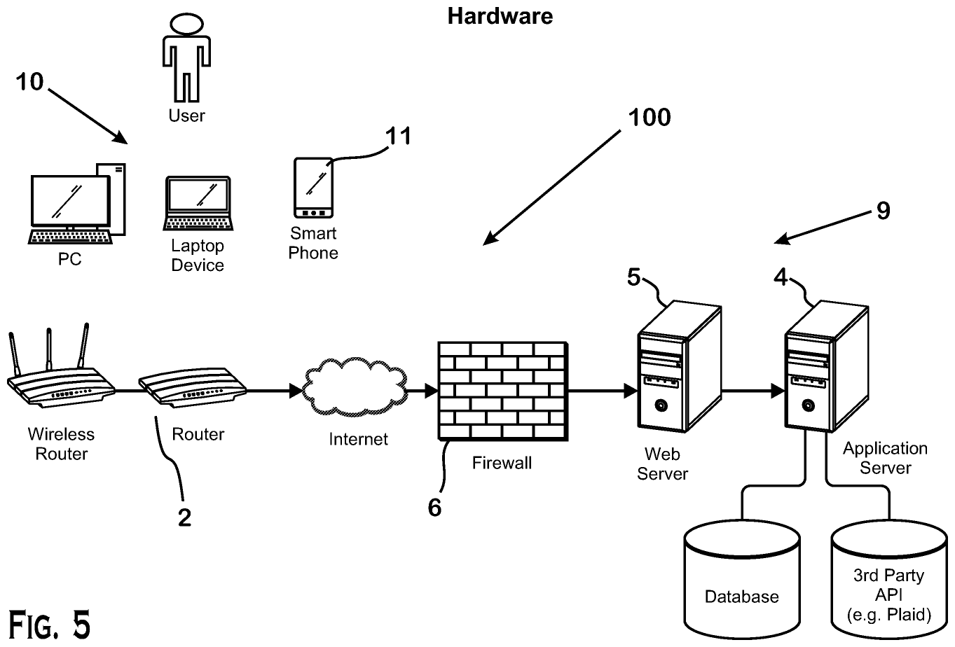

The savings simulation system 100 allows a user to access a plurality of user options through the computing device 10 and a network traffic information on the database application server 4 (i.e., SQLServer or PostgreSQL (also known as Postgres) or newer) that connects to a web server 5. The web server 5 functions as a way for the network router 2 to communicate to the database application server 4 using an application-programming interface (API) for communications between the computing device 10 and the database server 4. In an embodiment, the application database server 4 may house a data aggregator API that can connect to one of a database file for a financial institution, or governmental agency, such as the Bureau of Labor Statistics (BLS) or alternatively to a third party API that facilitates electronic access to the financial information of the user's financial account, using techniques known to those skilled in the art. A firewall 6 may be integrated for security purposes such as, but not limited to, blocking unauthorized access to the web server 5 and the resulting unauthorized communication thereto. The savings simulation system 100 is designed to run through the computing device 10 utilizing the saving simulation files for the application or program that are preferably loaded onto the user's computing device 10, such as into the memory of the computing device, and supplemented with information communicated through the network as will be discussed. It is contemplated that, alternatively, the savings simulation files may be downloaded through the network 9 from an application server 4. The savings simulation system 100 is designed to run through the computing device 10, and through a plurality of modules utilized in the savings simulation system that may be downloaded and function over any suitable network system 9, including personal area networks (PANs), local area networks (LANs), campus area networks (CANs), wide area networks (WANs), metropolitan area networks (MANs) and any new networking system developed in the future. One skilled in the art should appreciate that the savings simulation system 100 can be maintained solely through the computing device 10, as the investment feedback files can be pre-loaded to the computing device. In such an instance, the user may input details regarding the current financial account balance, thereby avoid the need to have the computing device 10 access a third party databases or API to update the account information via network 9. Additional information from outside sources may be updated less frequently than the user financial account information, for example, the BLS data may only be updated once per quarter (e.g. 4 times per year) or less, and thus may be updated through an application update on the user's computing device 10, rather than rely on frequent updates. In the shown embodiment, the user may connect to the network router 2 using the computing device 10 and update information through the network 9, for instance. FIG. 6 illustrates an exemplary embodiment of the front end and back end framework of the investor feedback system 100. FIGS. 7 and 8 also provide exemplary architecture and protocol for the savings simulation system 100. Though one skilled in the art would appreciate that other hardware and protocol designs are possible as long as such modifications would not divert from the spirit of the invention.

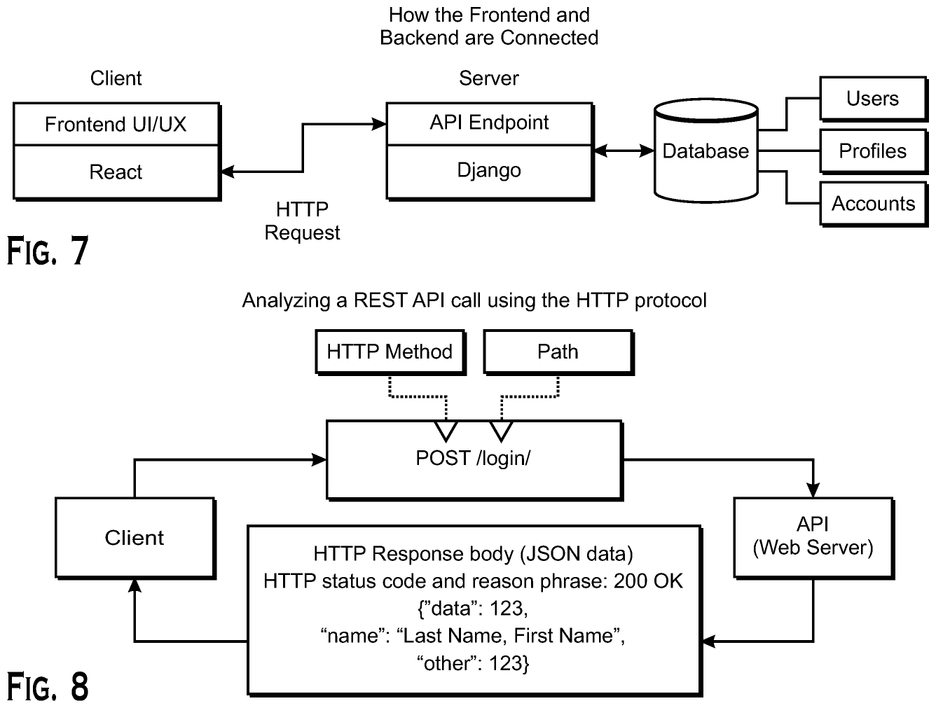

With reference to the schematic depiction of the savings simulation system 100 shown in FIG. 10, the computing device, as discussed above, and as known to those of skill in the art, generally includes a general user interface that can be detected on the display, a memory device 120, and a processor 110.

An exemplary embodiment of the process flow and interactions between component devices for the operation of the savings simulation system will be described with reference to the simplified schematic diagram of FIG. 10. The savings simulation system 100 includes a processor 110, having a memory 120, as may be associated with the computing device described previously, an application database 130, which may also be referred to as the system database. The integration system 100 further includes a communication gateway 150 and a plurality of service modules 160 executable by the processor 110. The service modules 160 may include at least one or more of, for example: an Authentication module, a “Landing Screen” module; a “My Profile” module; a “Career” module; an “Invest” module, and a “My Plan Summary” module, as will be discussed.

For exemplary purposes, the authenticator module is depicted in FIG. 10.

The processor 110 shown in FIG. 10 may be any type of computer processor known to those with ordinary skill in the art and capable of executing the processes described herein. The memory 120 connected to the processor 110 is any non-transitory computer readable medium known to those with ordinary skill in the art including, for example, persistent memory such as magnetic and/or optical disks, ROM, and PROM and volatile memory such as RAM. The memory 120 stores a plurality of algorithms executable by the processor 110. The various algorithms, when executed by the processor 110, implement an authentication module 152 and a routing module 154 of the communication gateway 150 and may also implement the services modules 160 as described in greater detail below. The memory 120 may also store a library of summary plan elements 122.

The communication gateway 150, in addition to the authentication module 152 and the routing module 154, includes a provider Application Programming Interface (“API”) 156 and a third party API 158 as shown in FIG. 10. The provider API 156 and the third party API 158 are each a set of software instructions stored on the system memory 120; each API 156, 158 is a set of subroutine definitions, protocols, and tools that, when executed by the processor 110, permits communication between disparate software components. Each API 156, 158 is configured to convert electronic data between different formats, such that the same electronic data is readable by each of the disparate software components. In an exemplary embodiment, the provider API 156 and the third party API 158 are both configured to convert electronic data between a JavaScript Object Notation (“JSON”) format and an Extensible Markup Language (“XML”) format. As would be understood by those with ordinary skill in the art, conversion between other known formats is also possible. In an embodiment of the invention, each API 156, 158 is a Representational State Transfer (“RESTful”) API, with a schematic of the interactions depicted in FIG. 8.

The savings simulation system 100 may be connected to and communicate with one or more third party financial institutions, financial portals, or job and data sources, such as government agencies 200 through the communication gateway 150 (e.g., over the internet) to integrate data related to the user's financial accounts or other statistical information necessary for the simulation, across the savings simulation system 100. Portions of the savings simulation system 100 may be cloud-based via the internet and may be located remotely from the user processor 110 and third party financial institutions 200.

The savings simulation system 100 may employ a savings simulation module utilizing, in an exemplary embodiment, the hardware depicted in FIG. 5. The savings simulation system 100 further relies on actions carried out by a plurality of service modules 160 helpful for carrying out various aspects of the invention, as will be described.

The Authentication Module

The authentication module allows for the secure log-in of the user, such as by using a password and username for the account that may be selected by the user during initial setup, and stored in memory for authenticating follow on events. It is also contemplated that alternatively, or additionally, one or more of personal identification number (PIN), challenge response, security token, hardware token, signature recognition, facial recognition, fingerprint scan, biometric data, and two-factor authentication credentials may similarly be employed to authenticate the user, as will be understood by those of skill in the art. The authentication module ensures that the user's identity is authorized or authenticated. Once the user's identification has been authenticated, the investment feedback system may be more fully utilized, such as by performing additional service modules, as will be discussed. Further, the user credentials for an authenticated user may be conveyed securely through the communication gateway, as may be required for interactions with a third party API 158, and/or for access to a third party portal, such as a for a financial institution hosting the user's account.

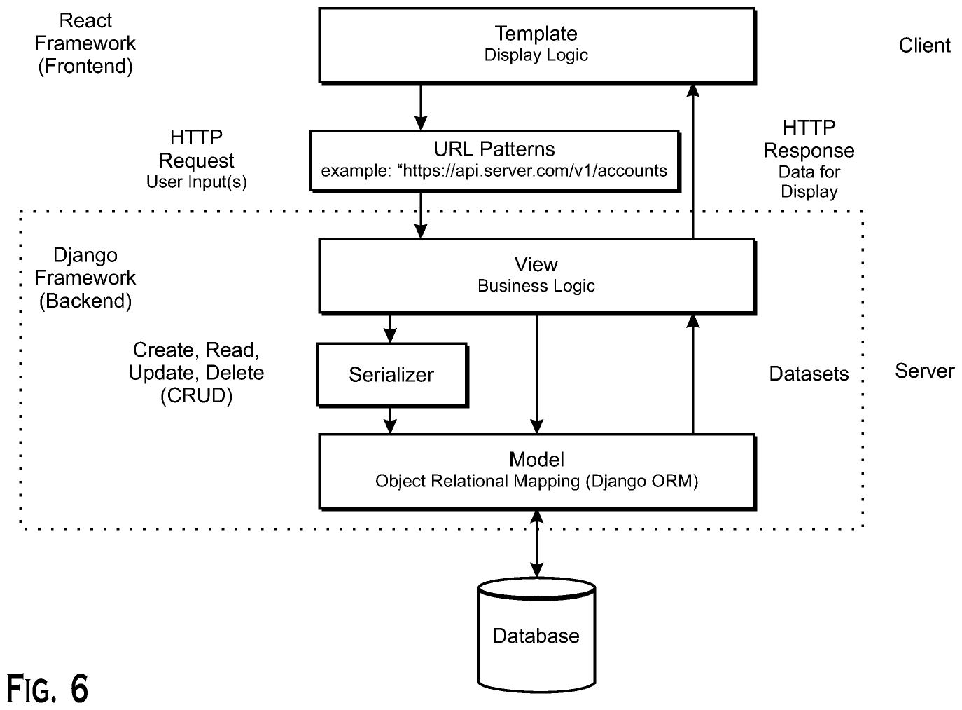

An example of protocol for the authentication module 152 is shown in FIG. 9, showing the interactions between client and server to verify and authenticate the user by providing login credential information, and token exchange.

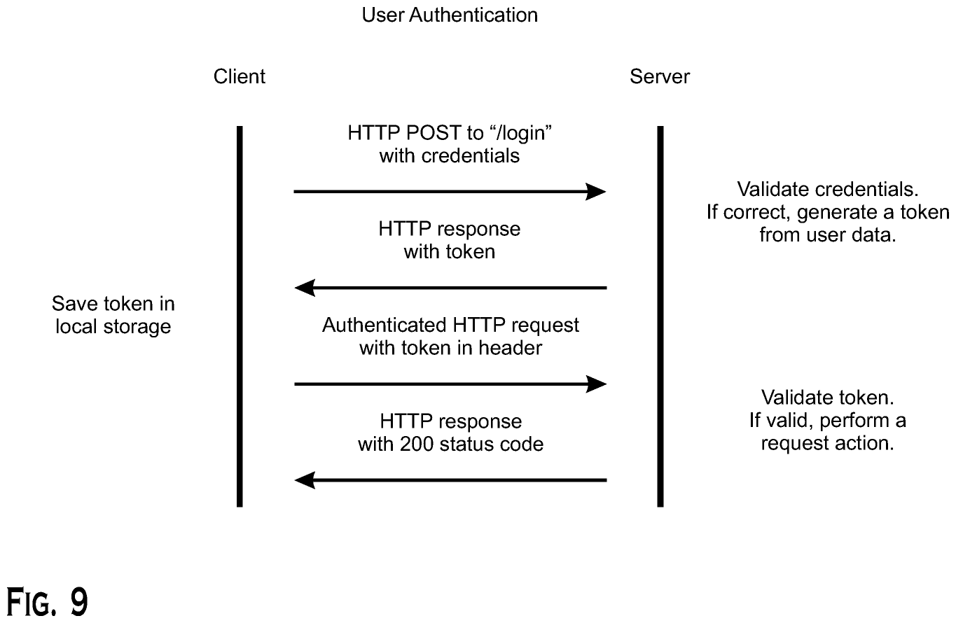

With reference to FIGS. 11-28, an exemplary embodiment of the performance of the simulation system 100, with there being provided exemplary images of the graphical user interface and examples of the service modules necessary for performing the tasks of the savings simulation module.

The Landing Screen Module

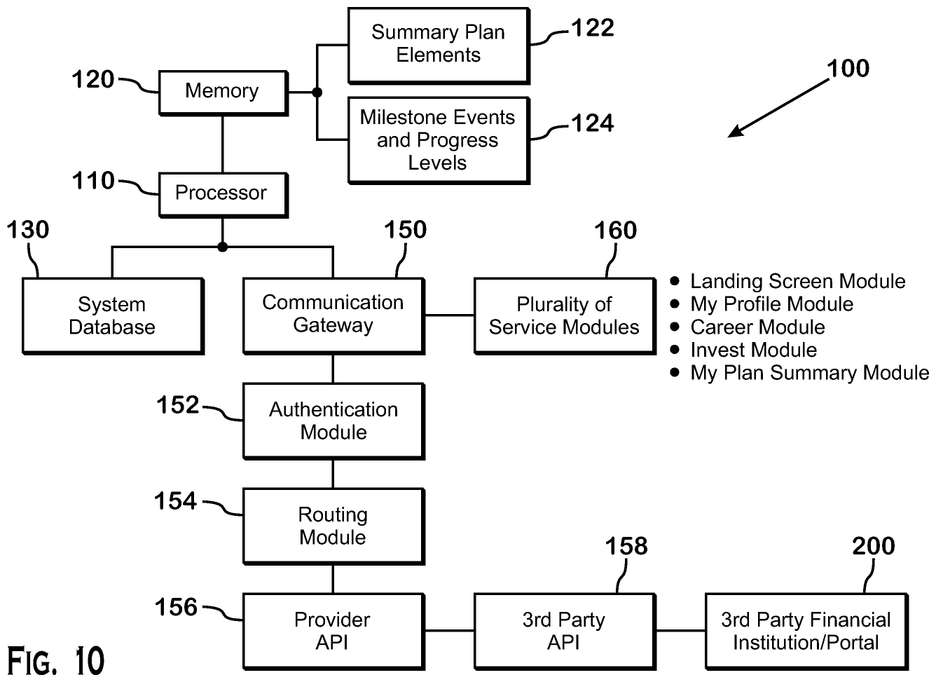

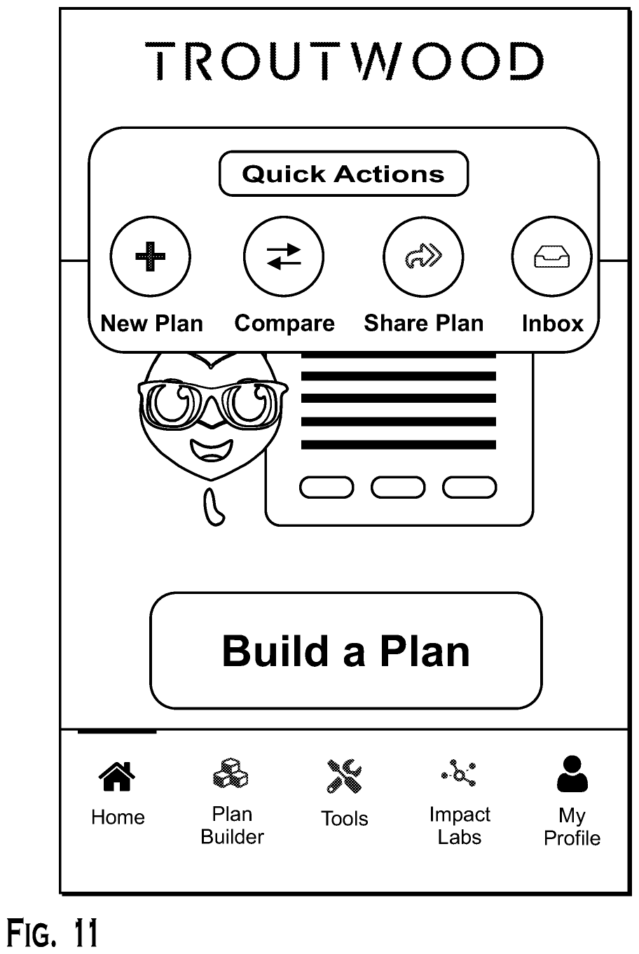

FIG. 11 depicts an embodiment of the user interface display for the landing screen module, where the user is provided the options to build a plan by selecting the Plan Builder icon, which allows the user to continue through a plurality of additional service modules described below. Selection of the Plan Builder icon will allow the user to access any saved plans for modification or review, or alternatively to begin a new plan, as depicted in FIG. 12, whereupon the user is allowed to continue through a plurality of additional service modules by providing information for the user's profile, career and investments, as will be explained. The landing screen module also provided the user the selectable icon of a home button to restart the software system, and again provide the landing screen. The option to select the home button is available at many points throughout the operation of the savings simulation module, should the user wish to return to the initial landing screen module. The landing screen module additionally provides the user selectable icons “New Plan”, “Compare”, “Share Plan”, “Inbox”, and “Build a Plan”. Furthermore, within the savings simulation system, there are provided a series of user selectable icons for “Tools”, “Impact Labs”, and “My Profile”.

Selection of the New Plan icon will prompt the user to enter the requested information needed to create a new financial plan for the savings simulation system 100, including user profile assumptions, career assumptions and investment assumptions, as will be discussed below. Selection of the Compare icon will allow the user to select from the current plan, and at least one of a plurality of plans already created within the system, such as may be stored in the application database, to compare the results of the selected simulations, and also may allow comparison of the information provided for the assumptions of the simulation. Selection of the Share Plan icon allows the user to cause the currently selected plan information, and results to be shared with another user, or alternatively, may be exported for observation by others, such as by sending the plan information in an email, text message, or social media post to a desired email or appropriate address provided by the user. Selection of the My Profile icon allows the user to enter the My Profile module, discussed below. Selection of Inbox icon allows the user to access a message inbox where communications may be received within the system, including messages that contain plans that have been shared to the current user by others. Additional icons may link to additional resources for the user to explore, such as the Tools or Impact Labs icons.

The My Profile Module

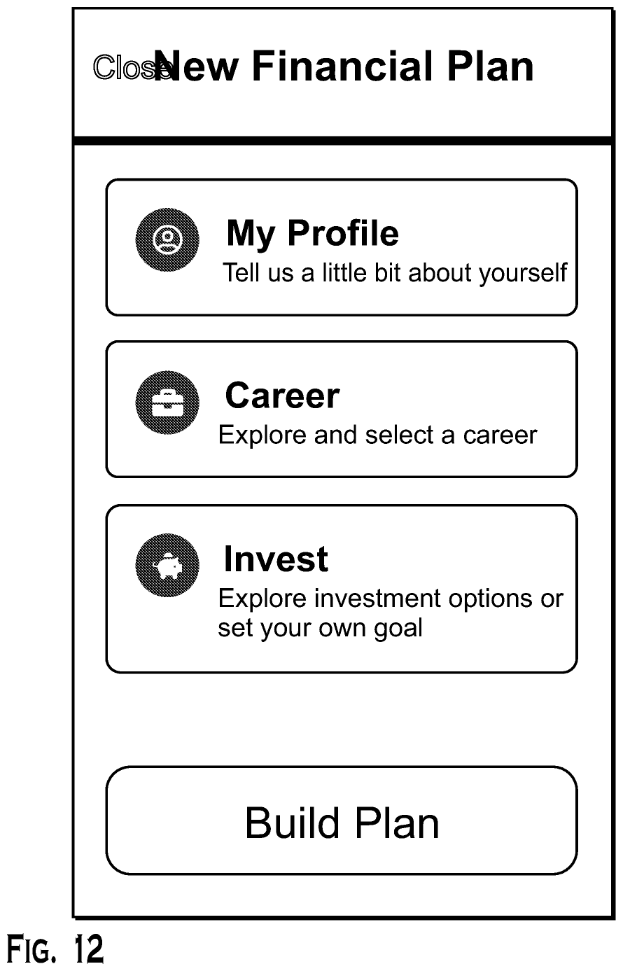

FIG. 13 depicts an embodiment of the user interface display for the My Profile module, where the user is able to enter relevant information about the user, which may be utilized in performance of the savings simulation module. As depicted, the user is able to enter information about the user's current age, location, and number of years the user wishes to save or invest. The number of years will typically correspond to the number of years until the user would expect to retire, though it may be any suitable number of years selected by the user. The location is provided by entering text into a search bar, and the system will provide a list of results that align with the text entered. The location information is typically selected by city and state, and corresponds to database entries for locations where the database contains information, such as the BLS statistics. Selection of the appropriate location allows the modeling to be reliable, as varying locations are subjected to different cost pressures and associated cost of living.

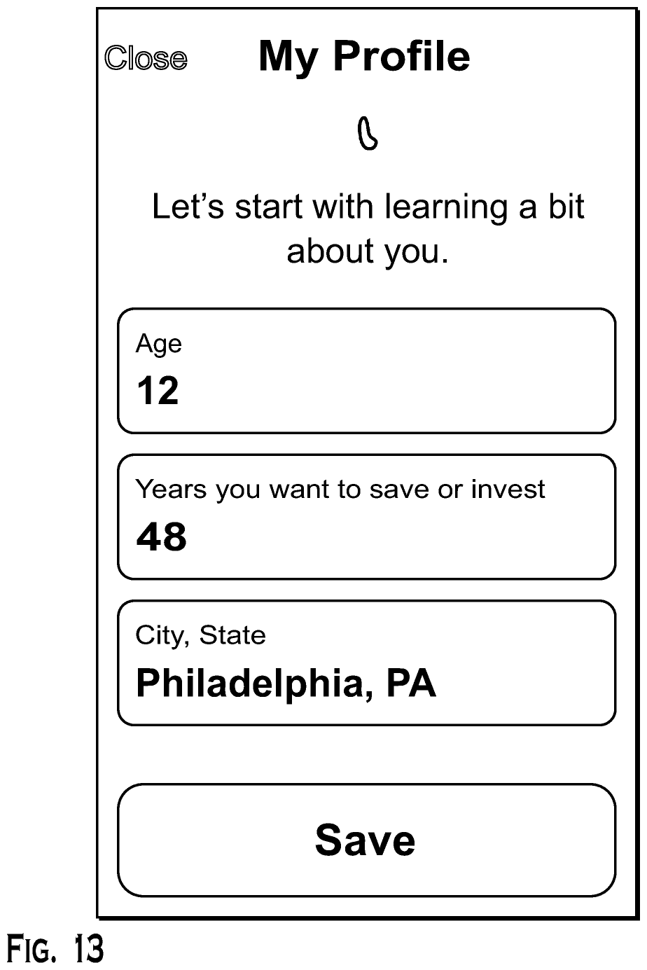

FIG. 14 depicts another embodiment of the user interface display for the My Profile module, typically after providing the age, years and location information discussed above. In FIG. 14 the user is asked to describe the status of student loans, and may select an option where there are no student loans, through a user selectable icon or slide switch (as shown), enter relevant information regarding student loans, real or anticipated, including a total balance, and average annual interest rate, and loan term. In an embodiment, the user may select an option to utilize the national average student loan information, such as may be useful where the user anticipates having student loans, but does not currently.

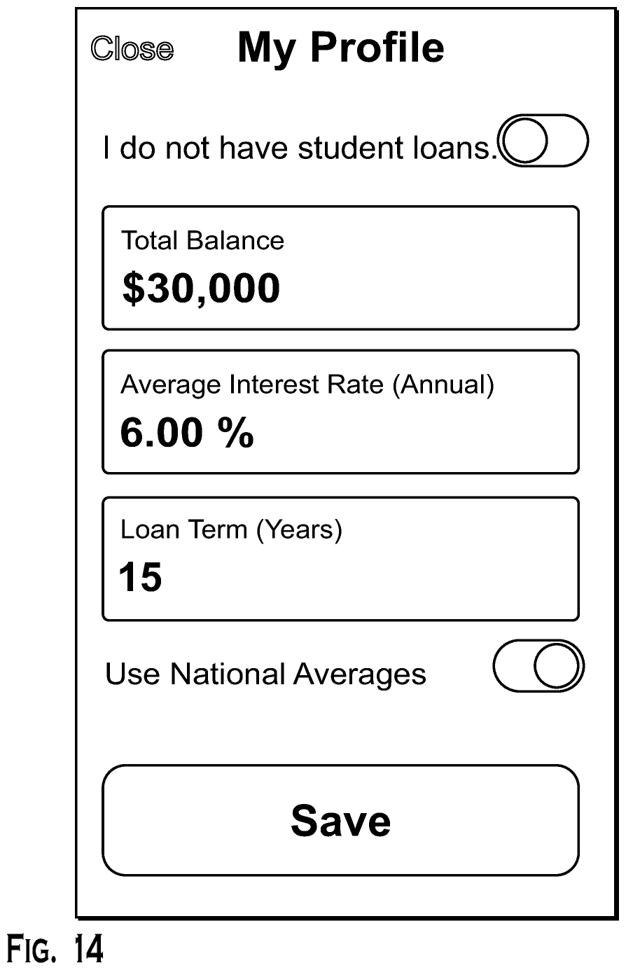

FIG. 15 depicts an embodiment of the user interface display where the user has completed the entry of information for the My Profile module, as indicated by the check mark, and indicates that user may begin the Career Module.

The Career Module

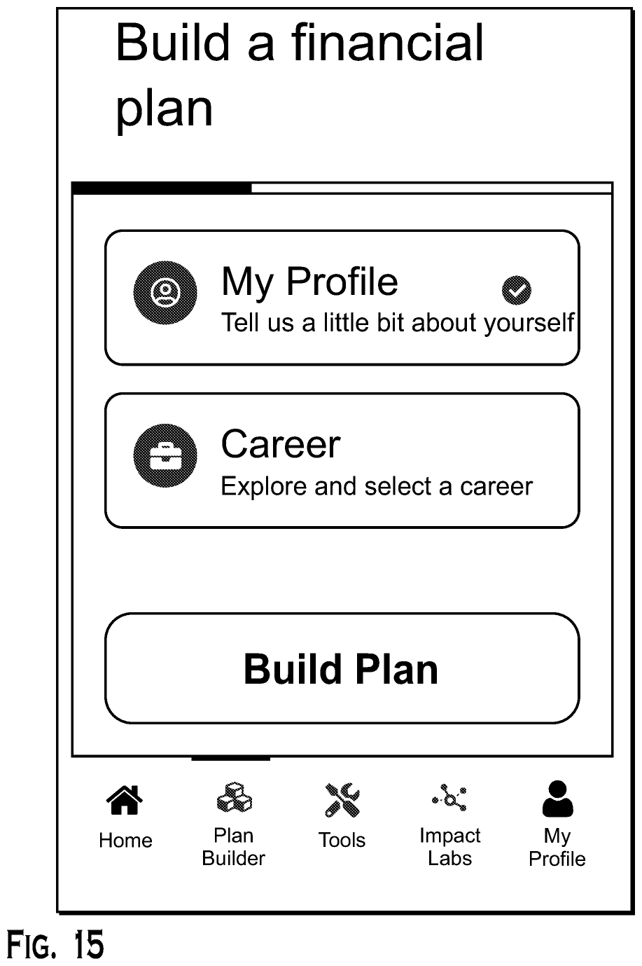

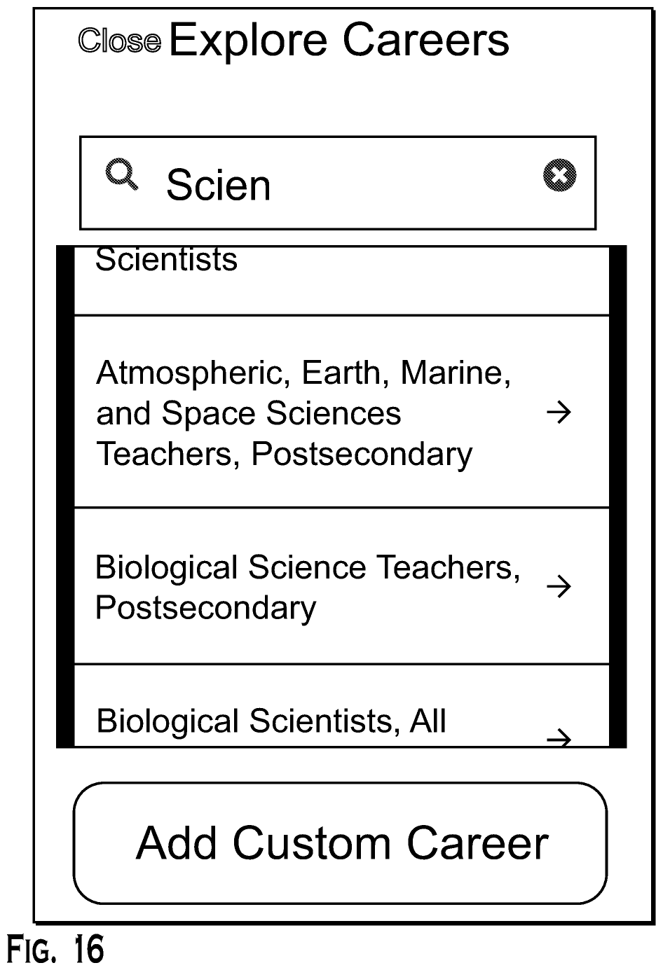

With reference to FIG. 16, the user is asked to select a career, whereupon the resulting career assumption information will be utilized in the savings simulation module. The user can search careers by entering a text string for the job title, or describing the career choice, and as the search string is entered, a list of results will be populated from which the user may select an entry, for example as depicted in FIG. 15. Alternatively, the user may select from a group of module provided career categories within the system, and as the user selects a category, a listing of available job entries in the database are provided that fall within the selected career category. For example, in FIG. 17 there is depicted the user interface where the user has selected the category of Healthcare Practitioners, and below is a partial listing of available specific titles that the user may navigate, e.g., by scrolling through the list, to select a specific job title. Once the job title is selected by the user, the saving simulation module will utilize assumptions associated with that job title using data that may be accessed from within the application, or within an application accessible database, or accessed via API connection (as described previously) to a third party database, for example, the Bureau of Labor Statistics database. In an embodiment, the career module may allow the user to explore career choices and gather information about jobs, independent of the savings simulation system, and a link to allow a user to explore the career module may be made available on the landing screen or other locations, as deemed appropriate in the application.

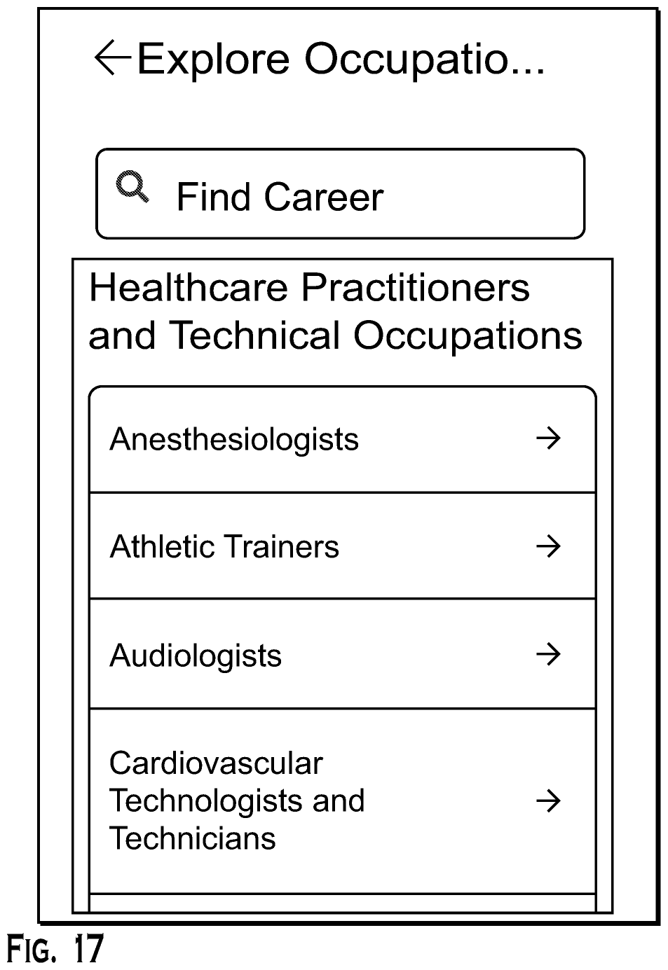

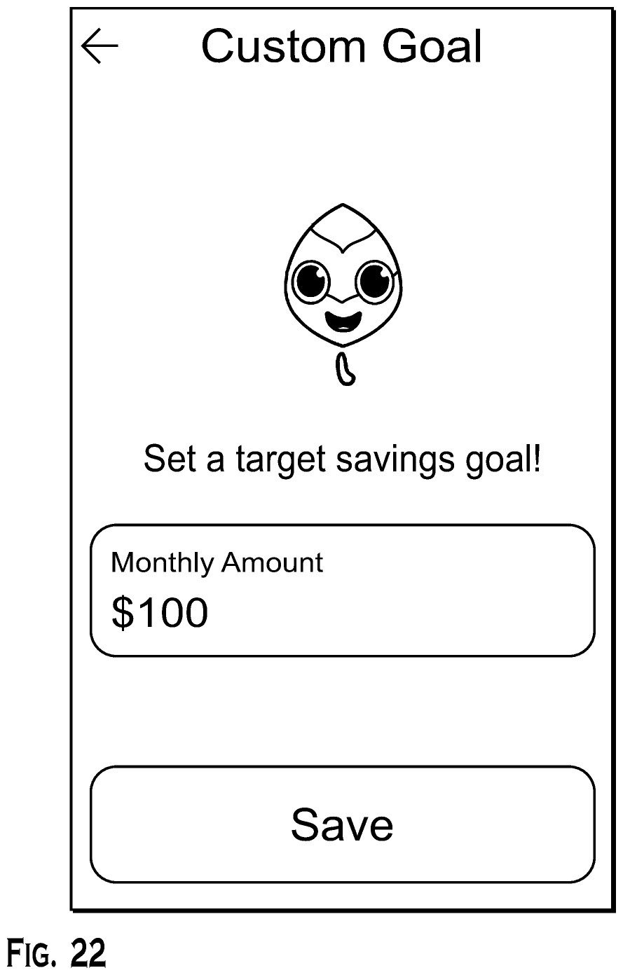

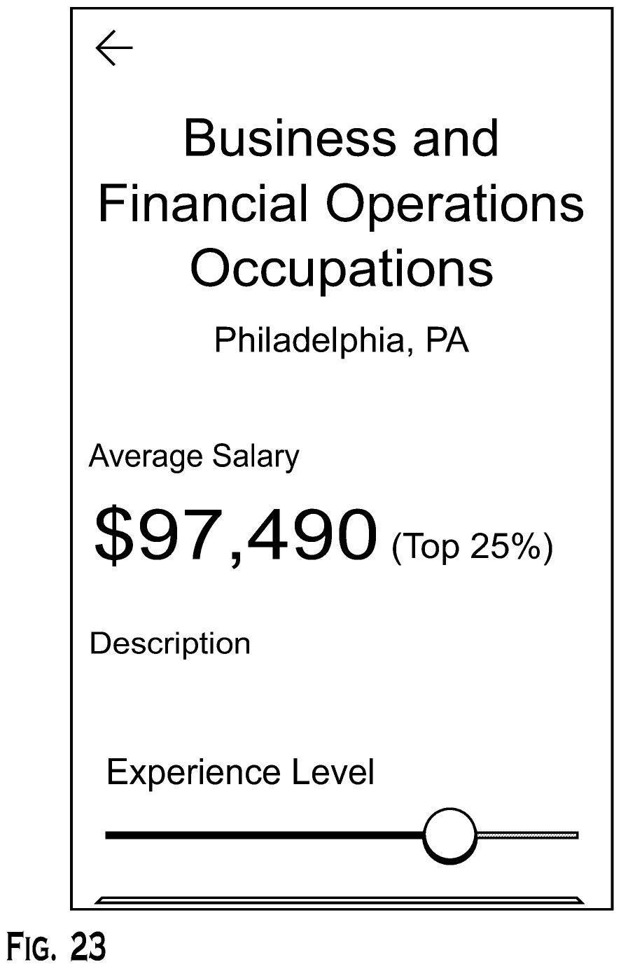

With reference to FIGS. 18 and 23, there is depicted an embodiment of the user interface display where the user has selected a job title of Athletic Trainer (FIG. 18), or an occupation in Business and Financial Operations (FIG. 23). The location for the job title is determined by the location information that the user has previously entered in the My Profile module. The user interface provides an average salary for the selected job title, and a description of the role. In this manner, a user may explore different job titles or career options. Additionally, the user interface may provide an adjustment option for the job title selected, such that the user can vary the amount of experience, which likely would impact the pay scale for the selected job title. As shown, there is a slider bar with which the user can interact to increase or decrease the experience level to apply for that job title in the assumptions within the savings simulation module, and accordingly will adjust the salary assumption to fall within a selected range from the accessed database, e.g., bottom 10%, 25^{th} percentile, median, 75^{th} percentile, top 10%, etc.). The user may review and confirm career choice, or edit further.

In an embodiment, the user is afforded great flexibility in selecting a career choice, and may opt to enter a custom career, providing a customizable job title and a customizable annual income that the savings simulation module will utilize as an assumption within the simulation.

Investment Module

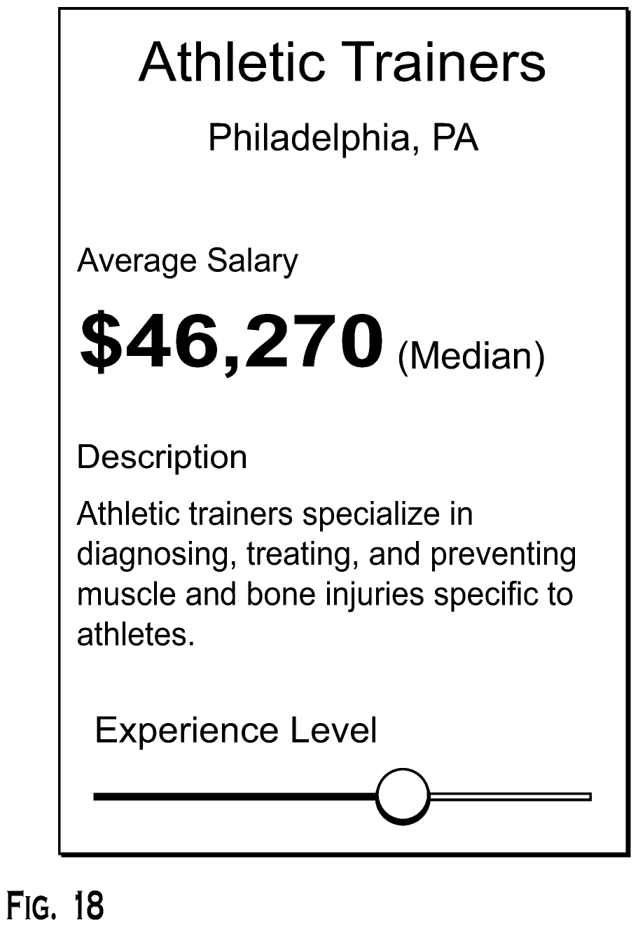

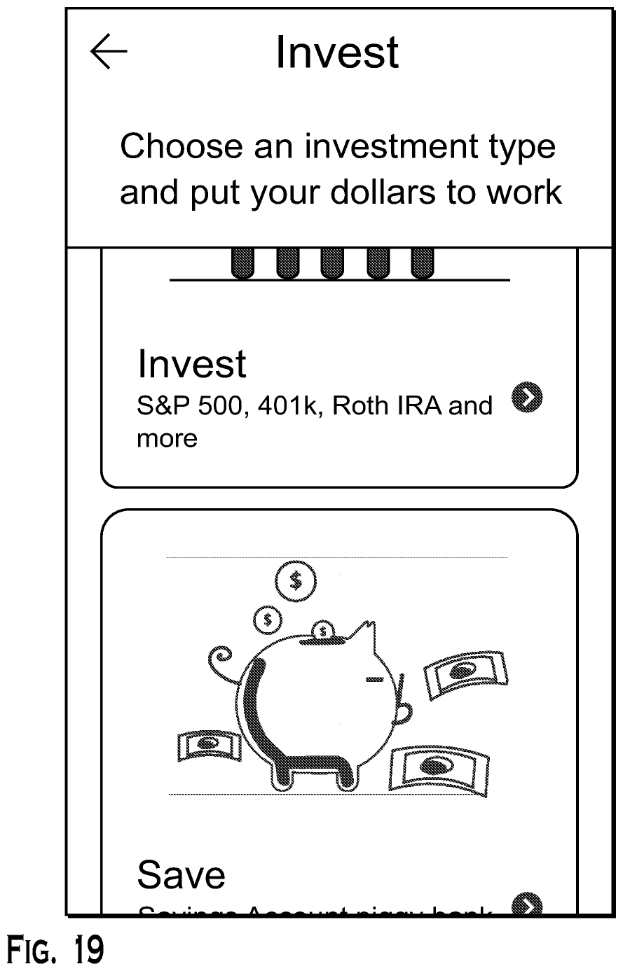

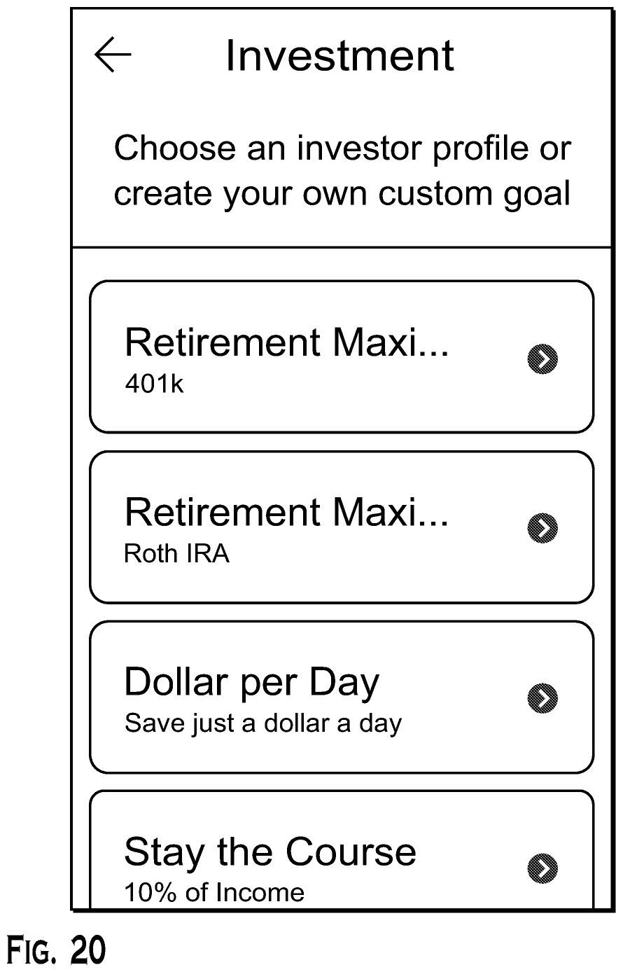

FIG. 19 depicts an embodiment of the user interface display for the Investment module, where the user is asked to select from an Invest module, or a Save module, for which to enter assumptions for saving and investments, as appropriate, during the years simulated. The investment module may also be termed a goal module, or goal profile module, as within the module, the user can set the goal amounts the user wishes to achieve.

Where the user has selected the icon for the Invest module, the display is caused to depict, for example, the representative images of FIGS. 20 and 21, where the user can select from investment options including Retirement Max 401K (maximizes contribution to 401K to limits set by IRS), Retirement Max Roth IRA (maximizes contribution to Roth IRA to limit set by IRS), Dollar per Day (contributes 1$/day or $365/year), Stay the Course (contributes set 10% of income to invest), Millionaire Maker (sets goal of $1,000,000), Billionaire Maker (sets goal of $1,000,000,000), or a custom goal defined by the user.

Selection of the different strategies results in different assumptions for the savings simulation module. For example, selection of the custom goal prompts the user to enter a monetary target, which the user would seek to achieve in the time frame established in the “My Profile” module. Entry of the custom goal amount would then be saved within the application or sent to a data aggregator API, which then sends to the appropriate database. An algorithm housed in either the Application or database analyzes the user input custom goal and assumptions, and calculates, based on historical or hypothetical rates of return for the investment market (e.g., S&P market index fund, or other suitable market fund) the annuity payment value which corresponds to the user inputted goal (as a future value) and selected time frame (number of years or number of periods, i.e., nPer). The investment return rates utilized in the savings simulation module may be based on information contained within the application, or accessed through a database, or API, as appropriate.

In an exemplary embodiment where the user selects “Millionaire Maker”, a monetary target goal (as a future value) is automatically set at $1,000,000. As before, based on previously described process for accessing historical or hypothetical rates of return in the invested market or fund, the savings simulation module will apply an algorithm to calculate the annuity payment value which corresponds to the user inputs and assumptions.

Similar processing would be applied for the other investment options, where the targeted goal amount is determined by the invest option selected, and applying the similar algorithm to calculate the required annuity payment to achieve the target amount in the time frame specified, using the historical or hypothetical return rate.

For example, selection of the strategy to invest 10% of income, automates selection of the annuity payment component of a standard Time Value of Money (TVM) formula to solve for Future Value, as would be familiar to those of ordinary skill in the relevant art.

For example, where the user has selected a job title with an annual income of $110,650, for instance, an Aerospace Engineer in Chicago, Ill., the user selection would automate input of 11,065 (i.e., 10% of the example annual $110,650 income) as the periodic payment (PMT)(e.g., weekly, monthly, or annual payment), in conjunction with the User's previously input Time Frame (e.g., 45 years) and the historical or hypothetical rate of return data (stored on the application or in the database, or accessed via API, as appropriate) to calculate the output for the user.

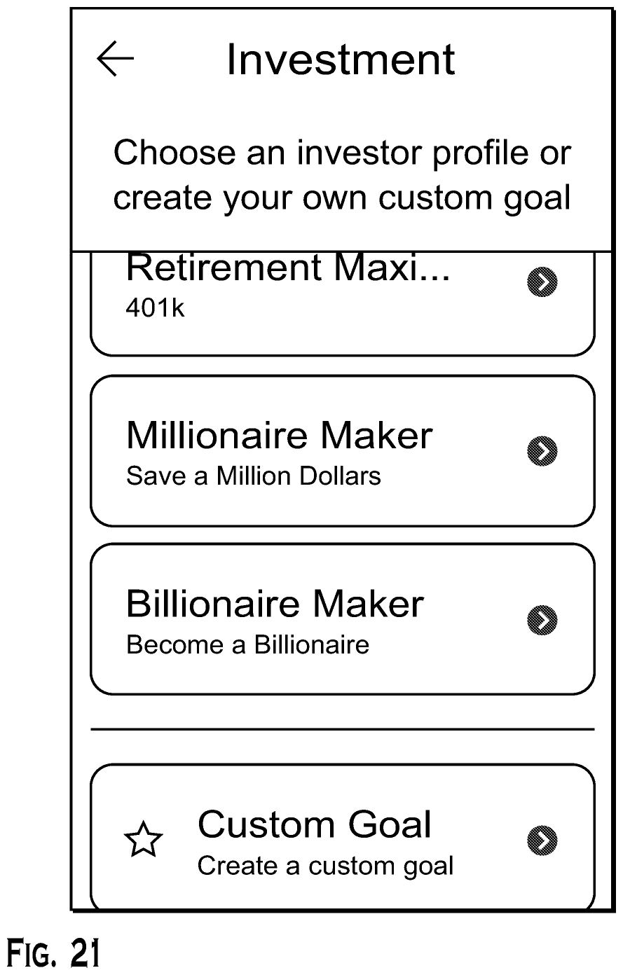

Thus, using the teachings herein, one skilled in the art, e.g. one familiar with mathematics, or economics, would be able to calculate the required annuity payment given the average rate of return, goal amount and time frame, using the known time value of money formula and having the rate of historical or hypothetical rate of return. One skilled in the art will understand that the techniques described herein for authentication, and access to database or API interface may be achieved using different techniques to achieve the stated goals described herein.

Where the user has selected the icon for the Save module, the display is caused to depict, for example, the representative images of FIG. 22, where the user is prompted to enter a monthly savings goal. The entry and confirmation of a savings goal causes the data to be stored in the application and/or sent to one or both of the database and Data Aggregator API.

An algorithm housed in either the application, or database and processed by the processor utilizes the user inputs for savings goal, time frame and calculates, based on historical or hypothetical rates of return data (for the selected investment type or investment strategy) stored in the application or database, the annuity payment value which corresponds to the user inputs for goal (Future Value) and Time Frame (nPer) using the formula for Time Value of Money as discussed above with reference to the invest module. With cash savings however, it is anticipated that the return from cash savings will be de minimus, thus the system applies a rate of return of 0%. It is contemplated that this may be adjusted within the system to a different rate as necessary, for example in an inflationary or deflationary period.

The user may then confirm the amount in either or both of the Save module and Invest Module. Thus completing the financial plan creation process by having provided information for each of my profile, my career, and my investment modules, and may depict a confirmation for each module on an intermediary screen, prior to selecting to “build plan”.

The My Plan Summary Module

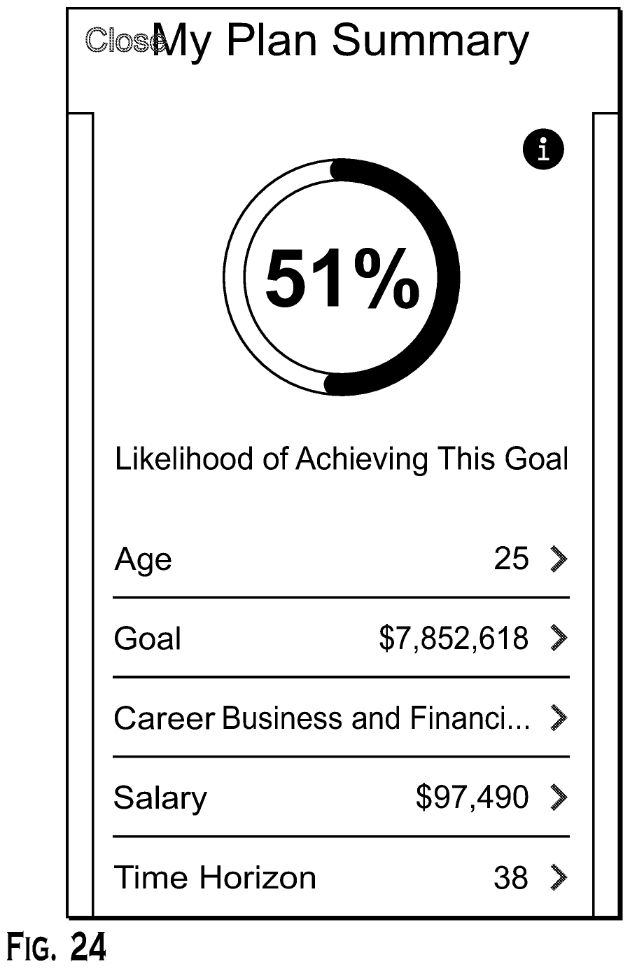

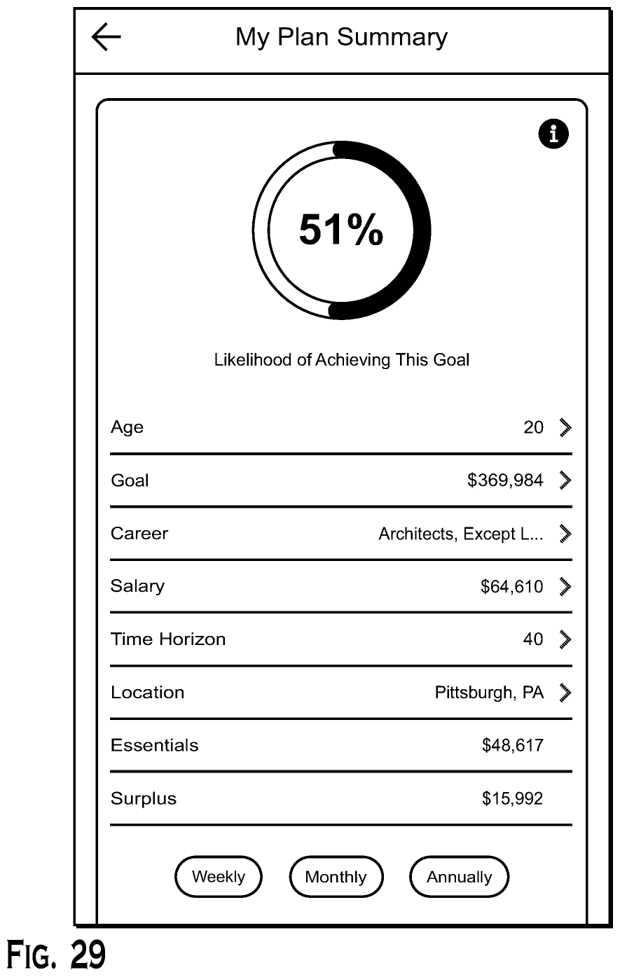

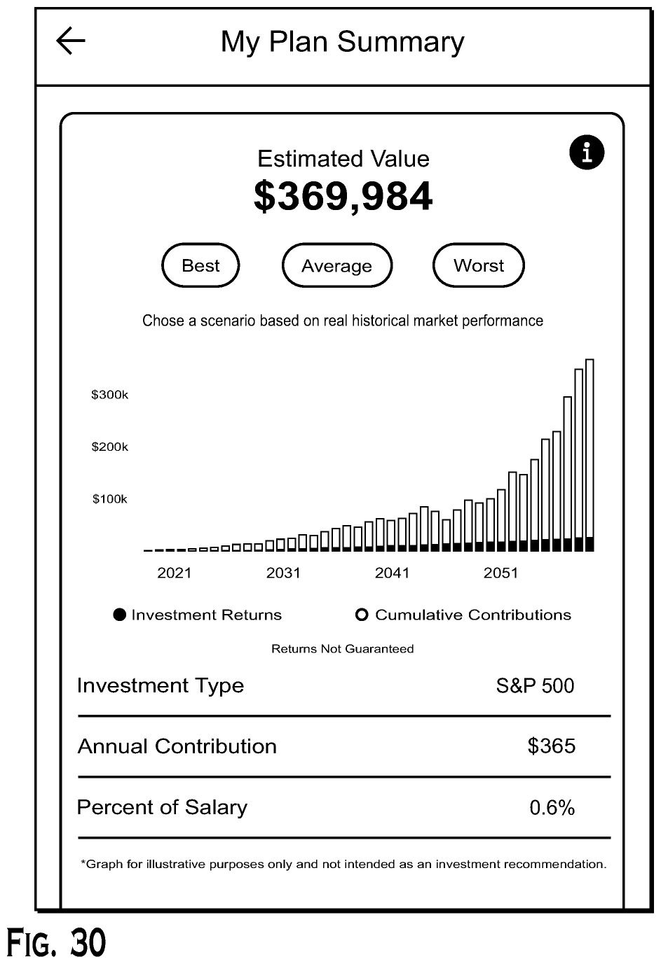

The user may be prompted to build a plan, where the savings simulation module, using the inputs generated, and necessary algorithms will result in the display of a financial plan, which can be presented by a “My Plan Summary” module, as depicted in the exemplary embodiment of FIGS. 24-28, and also another exemplary embodiment in FIGS. 29-30. The plan summary that is provided details the assumptions and relevant financial aspects as follows.

There is provided a summary element that indicates the statistical likelihood of achieving the financial goals set as inputs in creating the plan. That is where the inputs are such that, given even an assumed return rate on investments that is statistically lower than average, where the plan financial goals could be achieved, there would be a higher likelihood, possible nearing or achieving 100% likelihood, of achieving the goal. This likelihood would be reduced, for example, where the inputs (e.g. career choices, or location, or age and time frame) are less conducive to achieving the financial goals set, or where the average rate of return on invested amounts would have to be higher than historical average in order to achieve the goals. In such an instance, it becomes less likely than 100% likelihood, and the indicator would be reduced accordingly. In an extreme circumstance where the inputs entered are such that there is very low or no likelihood of achieving the financial goals set, the summary would indicate a very low percentage, even a 0% likelihood of achieving this goal. As depicted in FIGS. 24-28, the calculated likelihood of achieving the financial goals, with the inputs summarized therein is 51%.

The savings simulation module, in making a determination of the likelihood of achieving the financial savings goal within the period of time set by the user relies on an algorithm performed by the processor. The algorithm must weigh the time frame, e.g., years to save, until the goal is to be met (Time Frame). Additionally, the algorithm identifies the average rate of return for the user selected investment option, such as cash savings, or investment in the stock market through an index fund, for example, the S&P 500. The provider managed database has compiled the historical yearly rates of return within the system for the selected investment option, such that the application can identify all periods of corresponding (i.e., equivalent) Time Frame stored in the provider database along with the corresponding historical rate of return streams for all of those examined Time Frames, and thereby arrives at a statistical likelihood that is based on historical performance of the similar investment medium.

In an exemplary embodiment, a User inputs a Time Frame of 40 years and the process returns all historical data (rates of return and return streams) for 40-year periods stored in the Database, the corresponding return and return streams.

Based on the User selected Savings First Goal (i.e., the amount to invest each interval of the simulated plan) the algorithm performs calculations such that portfolio values are calculated for all corresponding return streams identified via the process described above.

In an exemplary embodiment, where $365 per year is the value applied to all historical return streams of 40 years in length. Continuing with the embodiment, the system identifies within the database 55 sequences of 40 years that are to be retrieved from the database, and the user input of $365 per year is applied to each, resulting in an output of hypothetical portfolio values at each point of each sequence. The algorithm is then applied to identify the sequence with the largest ending value (the Large Sequence), the sequence with the smallest ending value (the Small sequence), and the median ending value (the Median sequence). In such an embodiment, all of the sequences returned may be ranked, largest to smallest.

These data sequences (e.g. Large, Median, Small, etc.) are then rendered in graphic form via the application, for purposes of establishing a confidence interval and the User is presented with buttons (e.g. “Best”, “Average”, “Worst”) which they may select in order to view graphical renderings or data tables illustrating how their plan may have performed, hypothetically, during the historical intervals. Where the Best, Average, and Worst represent an assumption that the Best rates of return, the Average rates of return, or the Worst rates of return are applied, as selected by the user, in simulating the user savings amount through the Time Frame.

The system and process in the system thus include an algorithm which utilizes the Goal amount, as previously entered by the User, and determines the percentage of Time Frames (i.e., those return sequences) stored in the database that have terminal output equal to, or greater than the User's specified Goal. In an exemplary embodiment, and as depicted in FIG. 29, this percentage may be displayed as “Likelihood of Achieving This Goal”, having a value falling within the range of 0% to 100% (e.g., 51% as shown), and may further be provided in a graphic depiction, such as a circle chart, bar chart, etc., that provides a visual indicator of the likelihood of achieving the user selected goal. In this manner, the 51% likelihood measurement would serve as an indication that 51% of the sequences that are comparisons of historical returns for Time Frames with corresponding lengths, would result in at least meeting or even exceeding the set user goal.

The system may further provide an algorithm that measures whether or not the User's financial plan results in a Surplus or Deficit. If there is no Surplus, such as where a Deficit exists, the Likelihood of Achieving the Goal is output as 0% and/or the User may be prompted or elect to review the prior inputs.

In this manner, the user can adjust input entries, and weigh the effect that the revisions can have in the final output. Similarly, the user can create multiple savings plan within the system, and allow comparison between plans.

As can be seen with reference to FIG. 30, the user may select from Best, Average, Worst, for applying the historical rates of return, where the user can elect to display what is likely a more pessimistic view of the simulation, by selecting the “worst” icon. Conversely, the user can elect to display what is likely a more optimistic view of the simulation, by selecting the “best” icon. By default, the system presents the average, or most likely rates of return, initially, but the user can select any of the icons, and see the immediate effects displayed on the bar chart provided, by selecting any of the “best”, “worst”, or “average” icons.

Furthermore, as shown in FIG. 30, the My Plan Summary module is configured to identify the amount contributed by the user in the simulation (e.g., the monthly investment amount) and the cumulative contribution can be seen to grow with each year of the simulation. The My Plan Summary module may also identify the amount of growth on the contributed amount for each year, which will typically far exceed the amount contributed over the average length of a career, often exceeding 40 years.

The My Plan Summary module will include summary details for each of the inputs entered, including: Age, Goal (financial amount invested, or saved), Career, Salary, time horizon, location, Essentials and Surplus.

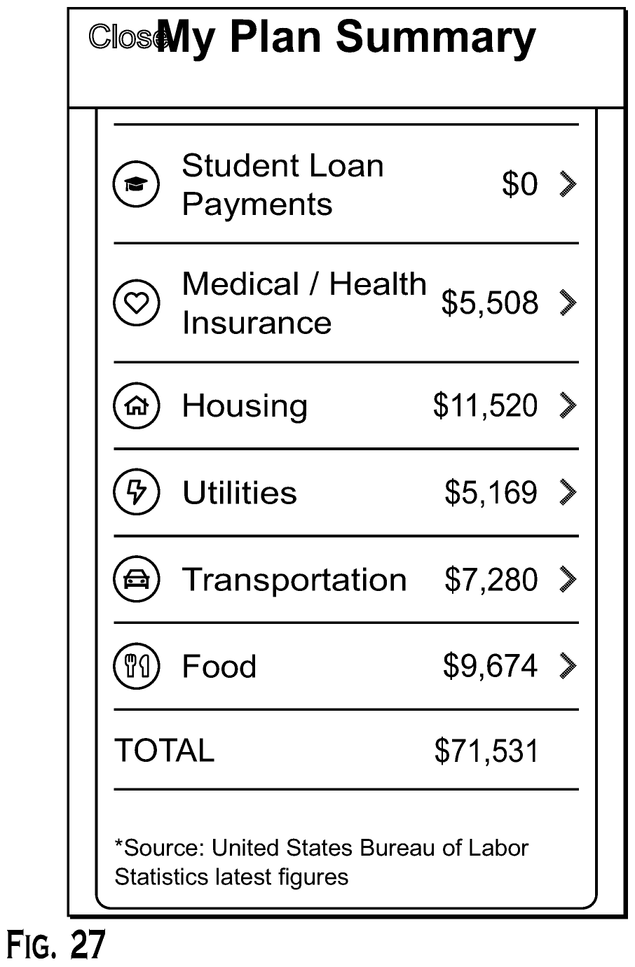

The essentials entails the living essentials, for example, those that are summarized in FIG. 27, and include student loan amounts, medical/health insurance, housing, utilities, transportation, and food, or other items that may be reflected in a user's personalized budget. These statistics are affected by location, and are provided in the database accessed by the system, in light of the location selected in the My Profile module.

As discussed herein, adjustments to expenses may be possible, by selecting one or more items within the “Life Hack” and “Add Ons” modules. Add Ons include those items that would ordinarily be considered non-essential spending, but are often desirable, and may include, for example, vacation, charity, pets, etc. Life Hacks include those items that help a user obtain and maintain the budgeted path toward a goal, for example, more economical housing and transportation arrangements, frugal food purchases, obtaining a second or side job. Where one could adjust the expenses downward using life hacks, by varying the living situation (e.g., select a modest house or apartment, take on a roommate to split rent with, live with parents rent-free, or adjust transportation to avoid car payments, or have reduced car payments with a more modest vehicle). Alternatively, living expenses may be adjusted upwards (with Add Ons) by taking on a car payment for a luxury car, living in an extravagant apartment or house, adding costs for yearly vacations, pets, etc.

Within the summary, the user may select any of the displayed items to edit it, and upon selection would be brought to the appropriate module for adjusting the entry. Once the plan is adjusted, or if the user wishes to save the plan for future review, there is a “save plan” module that when the icon is selected, causes the inputs, and calculated terms to be saved within one of application or database.

### Financial Simulation Game

In an alternate embodiment, the system may be utilized within an educational curriculum in financial matters. In such an instance, the curriculum instructor may assign career tracks to student users, who may be provided an opportunity to review and explore facts relating to a wide variety of career paths before selecting their own career path. Such a simulation game could provide students with critical life skills, as it prepares students running the simulation for real life choices they will face concerning finances, careers, and lifestyle choices, and see the impact those choices may have on their financial outcome in retirement. Additionally, the simulation game could provide instruction on basic budgeting and financial planning strategies, as well as imbue future investors with a proper mindset for better weathering financial crises, recessions, and economic downturns that may occasionally disrupt the stock market.

It is contemplated that a simulation game utilizing the systems described herein would offer approximately 900 career options for the students simulate within the system, though it is contemplated that more or less career options could easily be substituted. In another embodiment, the initial step in the game may be to create a random drawing, where the step of revealing the career the student has been assigned or chosen would generate excitement amongst the students in. By participating in the financial simulation game, the student may be exposed to the significance that earnings potential of different career options may play in achieving financial goals, along with lifestyle choices. Details on the specific career assignments may be made through the use of career cards, to be discussed below.

In practice, the simulation should ideally be kept simple, so that users are able to understand occurrences and events within the system, and is manageable by the teacher/game master. Additionally, the simulation ought to be fun, or gratifying for the user, so as to maintain user engagement and drive interest in the user's own performance within the game. In practice, the simulation would have access to historical stock market yearly performance, such as the annualized return. The simulation may apply a randomly selected annual return selected from the library of historical annual returns available within the system, and apply the selected annual return to a unit, so that each of the units within the simulation would have a simulated annual return based on prior historical precedent records for the market. In an embodiment, the simulation may allow the user, or the teacher/game master to elect the nature of the financial circumstances, rather than a random simulated historical return; in such an instance the simulation may apply an “average” return based on historical data, a “best” return based on optimistic rate of return, based on historical rates of return, or a “worst” return based on a pessimistic rate of return, based on historical rates of return. In addition to a randomly occurring market crash, it is contemplated that the teacher may be able to proactively push a stock market crash or financial crisis within the software, at the teacher's discretion, as part of the instruction events possible within the simulation. The emphasis within the system would be to teach student users that building investment savings is important, and the importance of continued or maintained investments, even in hard times, such as market crashes. The simulation game may have access to, or otherwise utilize the data utilized and collected through the personal savings calculator, including the BLS and HUD data, as well as expense data, for example.

In running the simulation game, the teacher or game master would oversee aspects of the simulation, such as ensuring the students are able to select a career option, as well as a location option which may be in the form of a zip code, or any of the geographic locales corresponding the data collected by HUD and BLS. The simulation game will play out over a desired number of units. In an exemplary embodiment, the number of units may be 42, corresponding to the average 42 year career span of an individual. The simulation takes the average career duration and breaks the long term goals of such a career into short-term goals, which may seem more actionable to the user.

In an embodiment, the first unit begins with a message to the user that the user has been hired, and the student is assigned a job corresponding to the career path selected. In gameplay, for each unit of the game, the user is tasked with answering a selection of life decisions, discussed in additional detail below. The choice selections made by the user in answering the requested life decisions will trigger calculations within the system and will impact the user's career progress, budget, financial outcome, and lifestyle choice of the user within the game simulation.

Each unit will require a user to respond to decision categories presented: pay decision, save decision, home decision, car decision, student loan decision, credit card decision and life decision. These decisions, discussed with detail below, will serve to direct the user's income stream (as determined by career path and title) into one or more of: the bank (representing savings); retirement/investment; and credit card (to reduce user's debt).

The pay decision faced by the user may address the possibility of an increase, maintenance, or decrease in the salary of the user. Alternatively the user may face job loss, retirement, or job change, or be awarded a promotion, or unlock an entrepreneur option for the user. The events in the simulation may be selected randomly, or may be adjusted based on the user's behavior, or teacher push actions. This pay decision is presented to the user in each unit by the system.

The save decision would require the user to select for each unit an amount of income to direct into the bank, a Roth IRA, other retirement account, other investment, or even not make any investment for the selected unit (thereby reserving all income for other purposes). This is a selected choice made by the user, in contrast to the decision presented to the user, as in the pay decision immediately above.

The home decision would require the user to decide for each unit between the options of renting a residence, saving to buy a residence, buy a residence, pay mortgage minimum on the residence, pay more than mortgage minimum on the residence, pay off the residence mortgage, sell the residence, or unlock the option to purchase a second home. The user may be able to indicate choices for how much cost the decision would incur or benefit to be provided. For example, the user may be able to select between a menu of residences, ranging from modest to opulent, and prices accordingly within the system. In the event that a second home is unlocked, the option may be provided for selecting a second house that would be in a desirable location, such as the beach house, a lake cabin, or rental unit, as non-limiting examples, again, the type and location of the second home would impact the cost or rent associated with the second home choice within the system.

The car decision would allow the user to select for each unit from the option of a car lease, car purchase, pay minimum on car loan, pay more than the minimum of the car loan, pay off the car loan, trade in current vehicle, keep the current paid off vehicle, unlock the option for a second vehicle. Each of the car and optional second car may be on selected from a menu of options, including a frugal choice, or extravagant choice, and priced accordingly.

The student loan decision would allow the user to select for each unit to choose to pay the default student loan amount, to pay a minimum amount towards the student loan (resulting in increased total interest upon the loan), to pay more than the default amount (reducing total interest on the loan), to pay off the loan entirely. The user may also unlock the option for graduate school within the system. The amount of the student loan the user is initially obligated to pay off would be affected by the career choice, and may be adjusted by the zip code or geographic locale selected.

The credit card decision presented to the user each unit would require a choice of paying for expenses including food, entertainment, fuel, and clothing. The expenses facing the user may also be affected by the geographic locale, and the career choice selected. The costs for the expenses may be deferred by being charged to credit card, but where the expenses exceed the current simulated bank account amount of the user for that unit, then credit card debt begins to accumulate, which would affect future units within the simulation.

The life decision presented at each unit, would allow the user to select various life changing events, such as to have a wedding and take on a spouse (the spouse having a randomly assigned career path, with relative income, and expenses), or to have children. While the option may be presented at each unit, the system would only allow the user to select a spouse once during the course of the simulation. Additionally, the system may present options at each unit for the user to pursue hobbies or travel, e.g. ski trips.

In the course of the simulation game, each of the student users is assigned or initially selects the starting career, and location, as mentioned previously. The system may allow flexibility, where the user may opt for a career change, which may be restricted to occurring at specific intervals or units. The system may recognize frequent career changes by the user, and may alter the simulation by assigning a factor of higher risk in response to the repeated career changes by the user. For example, the system may utilize a risk meter being based on cumulative points assessed as risky within the simulation, which upon a threshold score of the risk meter being achieved, the system may trigger the user, or the teacher may push a notification, stating that user's job has been terminated, and/or making rehiring into a new career more difficult.

In another embodiment, the system may additionally allow a student user to elect to attend graduate school or obtain professional certifications, or applicable career training. In another embodiment, the system may allow for the selection or advancement within the career path, allowing a plurality of career levels for the career selection. Such career enhancements may result in the simulation awarding raises, promotions within the career by progression of job title, or recognition of the training or certification may result in an opportunity to advance career progression (such as the system indicating an offer from a recruiter). The likelihood of career progression is higher where the user is able to maintain the risk meter at a lower level. In one embodiment, the risk meter incorporates employment/unemployment rate data associated with specific academic degrees and certifications, vis a vis specific career choices selected by the user.

Furthermore, the teacher or game master may have the ability to trigger or push events to selected individuals or users, or randomized samples of individuals or users. The push events allow the reinforcement of specific topics within the financial simulation game. Topics suitable as push events include, but are not limited to: the need for insurance (medical, homeowners, automobile) to protect oneself from negative impacts of outside forces such as weather, illness, natural disasters; Contributions to retirement accounts, such as Roth IRA contributions; attending or not attending graduate school. The selection of applying a push event need not necessarily be random, but could be triggered by the teacher in response to a user behavior that can be tracked or otherwise monitored by the teacher. For example, where the user is opting to not contribute towards a 401K in the simulation, and the push event might be designed to alter the behavior of the user, for example encouraging saving in a 401k by delivering push cards that would tend to trigger the student altering behavior.

The simulation game may evaluate user's against other users in the simulation, and may compare relative performances within select groupings, such as within one or more of: classrooms, grades, schools, county, state, or at a national or international ranking. The winner will not necessarily be the individual with the highest net worth or 401k amount at the end of the last unit, but would be based upon greatest statistical likelihood of achieving the retirement goal sought by the user.

It is contemplated that in exemplary embodiments the simulation game may optionally provide for educational aspects to be included within the system. For example, within each unit of the simulation, the system may present a summary of the top 10 performing stocks for a relevant period, and optionally describe the nature of the companies represented, or present fun or entertaining facts about the companies represented. The system may maintain a database that is updated to include relative facts or summaries about companies in the relevant stock market, for example, companies listed within the S&P500. Alternatively, the system may provide for each unit a historical overview of entertaining aspects of the market, such as may be included in a database with summary of notable events in market history.

In an embodiment, the simulation may optionally allow for charitable contributions, and include a list of available charities that the student user may elect to support, or alternatively, the student user may be permitted to create their own charitable foundation/organization. The system may collect data regarding the charitable contributions, as given a large enough population participating in the simulation, valuable sociological information may be derived from the statistics of charitable contributions.

In an embodiment, the simulation may allow for an optional retirement either during the course of the simulation, or at the end of the simulation. Within the simulation, the user may designate amounts to leave to charity, to spouses, to children, the selection of which may be dependent upon the nature of the retirement investments. In this manner, the student user may receive an overview of retirement fund possibilities, and the difference between different fund or account types (e.g. Roth IRA, trusts). Additionally, the system may demonstrate the impact of estate taxes, and simulate, and provide the users familiarity with tax minimization strategies, such as trusts.

In an embodiment, the simulation may allow for an optional Family Wellness package, wherein the student user opts to add children within the simulation, those simulated children may themselves have financial accounts created, to simulate and provide representative examples as instruction to the student user, through children oriented plans such as 529 plans for educational expenses, or 401K plans for children, as non-limiting examples.

In an embodiment, the simulation may optionally allow for a student user to activate an Entrepreneur option; where the student user takes on a higher level of risk, but with a significantly greater measure of reward within the simulation. It is contemplated that the entrepreneur option would be made available to the student user after several units, and where the student user has demonstrated choices that indicate the ability to prevail within the higher risk option; such as where the student user has achieved a threshold value of net worth or career level within the game that may serve to unlock the feature.

### Career Cards

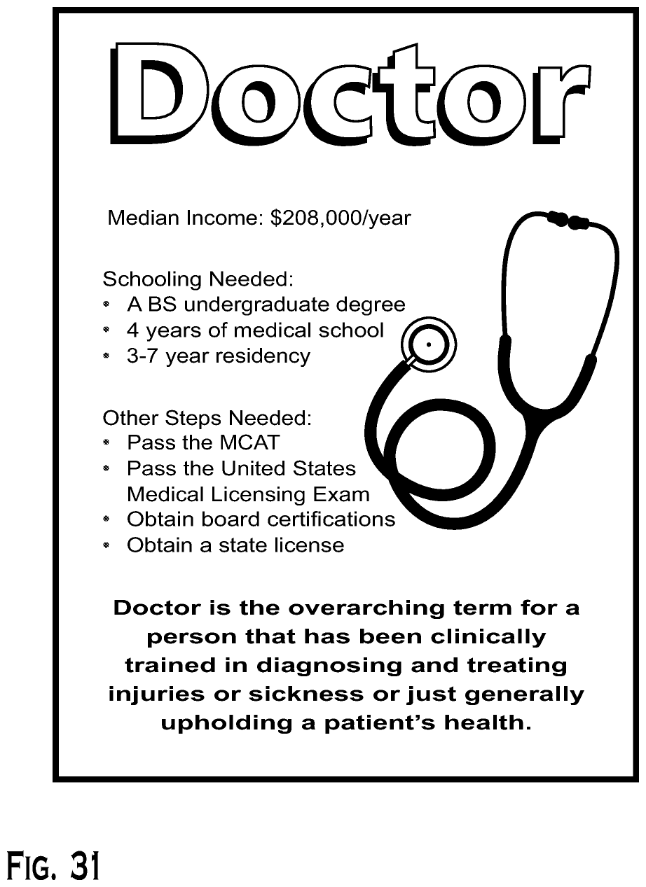

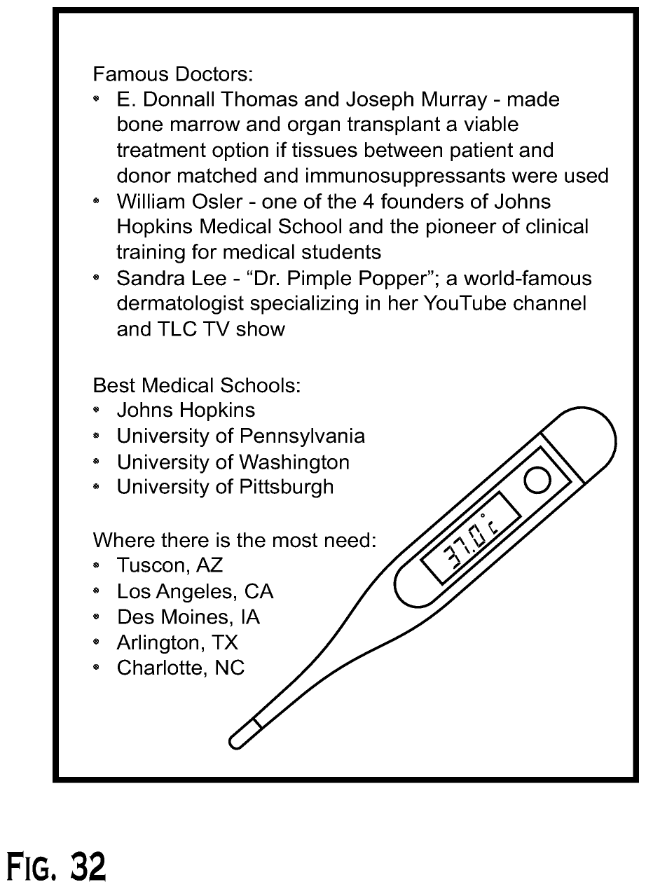

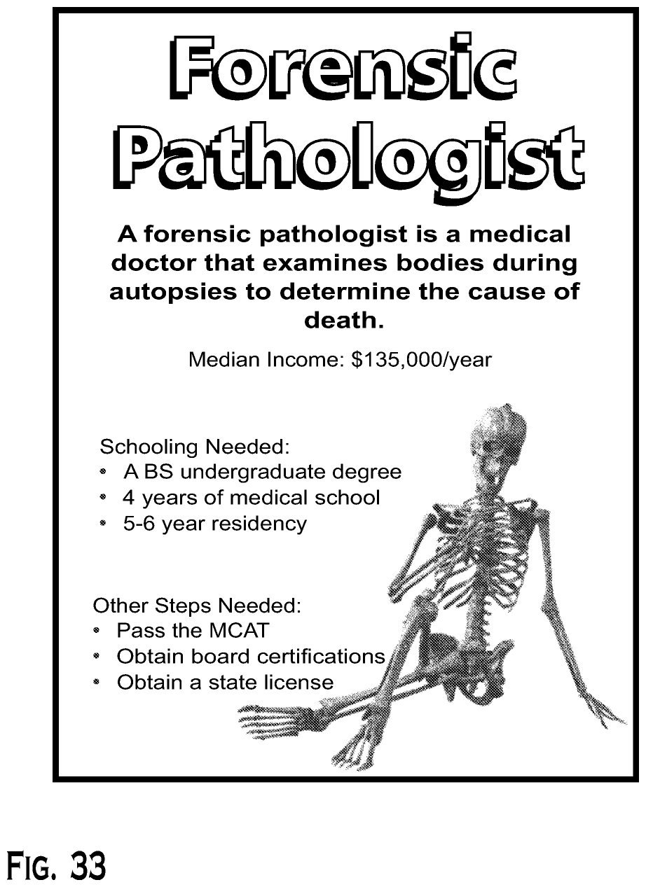

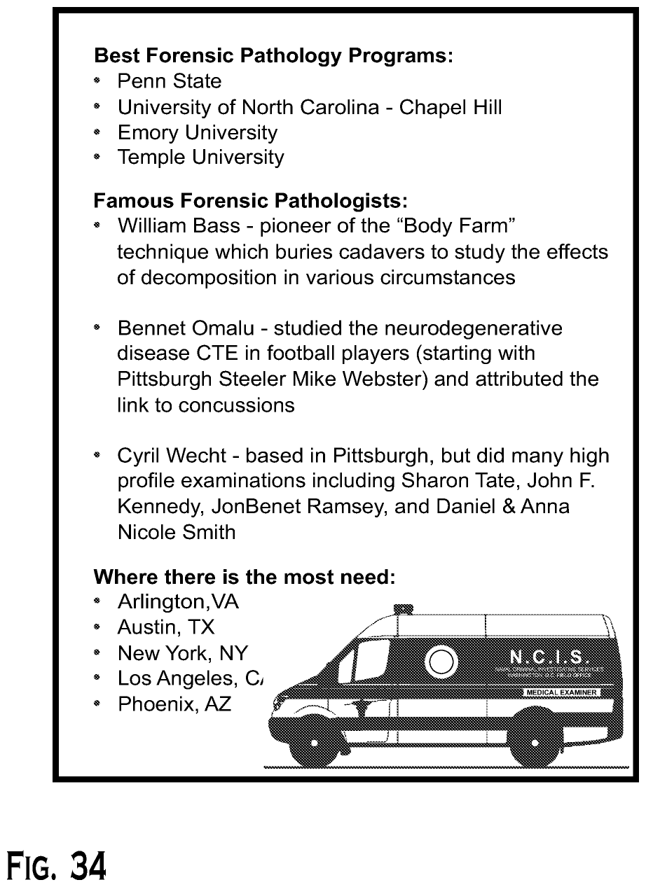

The system may provide career cards for the students to explore, which may be digitally created, or physical copies that may be distributed, where the career cards describe aspects of various careers, providing a summary of the nature of the career, and may provide detail, for example, on the level schooling required to enter the field, the licensing or registration requirements, the median income, examples of noteworthy people who have chosen such a career path, with some identifying information, and may identify locations with best opportunities to enter the field, The career cards are intended to generate student interest, and may be supplemented with easily recognizable graphics associated with the career, on one or both of the front and back. For representative examples of game card faces (front and back), see FIGS. 31-34.

In practice, the Financial Simulator game would have each of the participants take on a career path, and would over the course of a much reduced period of time, for example in the range of a few hours of game play, simulate a career in that field, and simulate the financial and life choices faced by actual persons in that career path. The simulation may provide for advancements or promotions within the selected career path, and may have a plurality of levels, such as any of 3, 4, 5, 6 or less than 10 levels for advancement, associated with each career. The game play may be spread out in time increments through a portion of an academic semester or year, or within unit of study. For example, an average career length is approximately 42 years, thus, for the game play there may be provided 42 units of the simulation, with each unit representing one year of the average duration career. The length of the simulation (e.g., the number of units, or duration of game play) may be altered, without departing from the spirit of the teachings herein.

The foregoing illustrates some of the possibilities for practicing the invention. Many other embodiments are possible within the scope and spirit of the invention. Therefore, more or less of the aforementioned components can be used to conform to that particular purpose. It is, therefore, intended that the foregoing description be regarded as illustrative rather than limiting, and that the scope of the invention is given by the appended claims together with their full range of equivalents.

What is claimed is:

1. A savings simulation system, comprising:
a single general user interface; and
a computer connected to the single general user interface and having:
a computer readable storage device having a database module for collecting, storing, and linking data associated with financial performance of a user account; and
a central processing unit connected to the single general user interface and the computer readable storage device, and running a plurality of core modules running:
a means for input for a user to select:
a locality;
a profession;
a lifestyle choice;
a selected number of years of run simulation; and
a user's personal savings goal;
means for retrieving real-time income and cost of living expense data from a third party based on the user input of a selected locality, profession, and lifestyle choice;
means for presenting a simulated scenario modeling a financial outcome based on the user inputs and real-time income and cost of living expense data; and
means for generating a proposed financial plan for the user based on historical rates of return.

2. The savings simulation system of claim 1, wherein the plurality of core modules further generate a personal savings calculator to provide an amount to invest for each year in retirement savings to meet the user's personal savings goal.

3. The savings simulation system of claim 2, wherein the plurality of core modules includes a landing screen module to provide the user options to build the proposed financial plan.

4. The savings simulation system of claim 3, wherein the plurality of core modules further includes a my profile module permitting the user to enter information about a user's current age, a location, and a number of years the user wishes to save to meet the user's personal savings goal.

5. The savings simulation system of claim 4, wherein the my profile module permits the user to enter information regarding status and amount of student loans.

6. The savings simulation system of claim 4, wherein the plurality of core modules further includes a career module permitting the user to select a job title of the profession.

7. The savings simulation system of claim 4, wherein the career module further permits the user to select a level of experience for the job title of the profession.

8. The savings simulation system of claim 7, wherein the plurality of core modules further includes a invest module permitting the user to enter inputs directed to expected saving and investments during a number of the selected years of simulation to define the user's personal savings goal.

9. The savings simulation system of claim 8, wherein the plurality of core modules further includes a my plan summary module that generates a report directed to a statistical likelihood of achieving the user's personal savings goal.

10. The savings simulation system of claim 8, wherein the my plan summary module further generates a further report establishing a confidence interval.

11. The savings simulation system of claim 8, wherein the locality is a geographical region.

12. The savings simulation system of claim 11, wherein the lifestyle choice is directed to spending nature of the user.

13. The savings simulation system of claim 8, wherein the retrieved data is collected by governmental agencies or labor industries.

14. The savings simulation system of claim 1, wherein the proposed financial plan is dependent on the income data of a selected profession and cost data of living expenses for a selected geographical area from the user input.

15. The savings simulation system of claim 1, wherein the proposed financial plan is a budget plan that is specific to the user input of an estimated recurring amount of monthly contribution towards the user's personal savings goal.

16. The savings simulation system of claim 15, wherein the proposed financial plan generates a report indicating a likelihood of success of achieving the user's personal savings goal based on historical market return data for a selected investment vehicle.
